(19) United States
(12) Patent Application Publication
(10) Pub. No.: US 2005/0182735 A1
(43) Pub. Date: Aug. 18, 2005

(54) Method and apparatus for implementing a micropayment system to control e-mail spam

(76) Inventors: Robert Philip Zager, Saratoga, CA (US); William Ames, San Jose, CA (US); Jose Jesus Picazo JR., Los Gatos, CA (US); Nageshwara Rao Vempaty, Palo Alto, CA (US); Vikram Duvvoori, Salinas, CA (US)

Correspondence Address: RONALD CRAIG FISH, A LAW CORPORATION, PO BOX 820, LOS GATOS, CA, 95032, US

(21) Appl. No.: 10/778,956

(22) Filed: Feb. 12, 2004

(51) Int. Cl. G06F 17/60

(52) U.S. Cl. 705/67

(57) ABSTRACT

A micropayments method and apparatus to control spam using a centralized server architecture. The central server receives requests from senders who want to send emails, and determines if the sender has a micropayments account with an adequate balance. If so, an encrypted stemp is sent back to the sender and the amount of micropayment is deducted from the account or transferred to the recipients account. The key and a serial number of the message is saved in the server. The recipient computer receives the email, sends the serial number to the server and requests the key. The key is looked up and sent back to the recipient. Many alternative embodiments are disclosed such as centralized stemp decryption, centralized white lists, decentralized key decryption, one key used all the time for a particular recipient, transfer of value to recipient only upon opening message, etc.

### FIELD OF USE AND BACKGROUND OF THE INVENTION

The problem of spam email on the internet has become epidemic and very annoying to users of email. Every day, users of e-mail have to waste time deleting unwanted emails to keep their inboxes from filling up with thousands of messages and wasting their hard disk capacity. Some junk emails are embarassing in terms of the products they are attempting to sell such as Viagra. Other emails are just plain annoying such as emails from sellers of tickets for concerts and other events because they take a long time to load and will not let the user abort the loading process nor delete the email until it is done loading.

Junk email is sent by “spammers” who buy email mailing lists with hundreds of thousands or millions of email addresses. The problem was described in the Nov. 24, 2003 issue of Newsweek (pp. 66-68). That article describes a 32 year old former restaurateur, turned spammer whose company clears $2 million in sales every month by sending out 80 million email advertisements every day. These emails hawk diet pills, porn sites, sexual aids and miracle “As seen on Oprah” products.

This spammer sees nothing wrong with unsolicited bulk commercial email, and notes that spammers are relatively immune to lawsuits because they can “set up in another country within an hour.” Thus, by escaping the jurisdiction of the U.S. courts, personal jurisdiction cannot be obtained, and judgments cannot be collected, if any are successfully obtained. The 32 year old spammer notes that there are people in other countries who “would love to sell us bandwidth.” This spammer is so overconfident, that he lists his phone number on his web site.

Worse still, most virus attacks on the internet are arriving by email. Viruses arrive in the form of unsolicited email with an intriguing subject line which causes an unsuspecting user to open the email or open an attachment to it. The attachment contains a virus program which can damage their data, take over their computer and turn it into a robot or zombie doing the bidding of the attacker or making copies of itself and sending itself to everybody in the user's address book.

The unpleasant fact of life in the cat and mouse game of internet spamming is that the spammers are winning and the contest is not even close.

Annoying email users is not the only problem with spam. In the past two years, spam has congested the internet threatening to overwhelm internet service providers. Spam is now approximately 58% of all email traffic according to Gartner Group as of December 2003. That figure is up from 38% as of December 2002. Ferris Research says spam puts a 9 million dollar drag on productivity every year as workers waste time deleting unwanted email. Some unwanted emails are promoting financial scams such as most emails from Nigeria.

The forces who say they hate spam such as politicians, technology companies, beleagured email users and anti-spam vigilantes who spend their own time and money trying to clean up the net, have not as yet managed to even make a dent in the problem. Current approaches are not working. Even though home users and many companies began filtering their email two years ago, the overall amount of junk mail has ballooned exponentially. Filtering and antivirus companies always seem one step behind the nefarious spammers.

Most individual lawsuits against spammers have been defeated under freedom of speech grounds, settled or concluded with penalties levied against the spammers going unpaid and their email operationg going on unscathed. Efforts in Congress to pass legislation against spammers have been neutered by mainstream companies who wish to preserve the internet for advertising.

Prior attempts to solve this problem have failed. Filtering software is available and some providers such as Earthnet provide filtering functions to put suspected spam in a separate folder that the user can deal with at will. This does not solve the problem because the spam is still on the provider's servers taking up space and otherwise wreaking havoc. The email servers of AOL and microsoft sag under the weight of a billion blocked spam messages every day. Smaller ISPs that get fewer messages suffer even more. For example, the owner of The World, a small New England ISP arrived at work one day in November 2003 to spend three hours personally sifting through his jammed email server and deleting thousands of messages his filters caught.

Filtering out messages from known spammer addresses only works for known spammers, and more pop up every day. Further, known spammers are constantly setting up new email addresses from which to send their spam.

Filtering on content does not work reliably either. CipherTrust, an Atlanta-based, anti-spam firm uses a combination of technology in its filtering products: it hunts for specific words; blocks the addresses of repeat offenders and analyzes information at the top of a message to look for telltale signs of spam. These techniques block many spam messages from getting to the user, but some messages masquerading as legitimate messages get through and some legitimate messages which happen to use a blocked word do not get through such as emails advertising a walk to raise money for breast cancer research. As a more dangerous example, a message masquerading as an upgrade from Microsoft and carrying a virus successfully got through the CipherTrust filter. This virus attack email looked like a legitimate customer service message, and was thus impossible to detect by filtering software which looks for betraying words or phrases. It also was not sent by any known spammer, so address blocking did not work. Further, CipherTrust had not previously seen any other messages like it, so there was no filter template or pattern recognition software available to catch it either. The virus that got through the Ciphertrust filter was a new and deleterious kind of attack. It sought to turn a PC into an unwitting bulk email generator that remotely does the spammer's bidding.

In November 2003, more and more of these so-called zombie virus attacks have occurred on college campuses. After a recent football game at Texas Christian University, network administrator Bryan Lucas returned to his office to find his campus servers pumping out a hundred thousand emails for prescription drugs. He tracked the problem back to the laptop of the football team's bewildered punter who has unwittingly downloaded the zombie attack virus. Lucas stated that this was the fourth such attack in the fall semester of 2003.

Prosecution and litigation has not worked out either. First, sending out bulk commercial email is legal and protected by the First Amendment. However, zombie attacks are clearly illegal. Why aren't spammers who engage in these types of illegal attacks going to jail? First, it is nearly impossible to trace the original spammer through the hijacked computers to other computer locations that usually have long since been abandoned. A spammer can get an IP address from a DHCP server anywhere in the world, and the DHCP server does not know the physical location of the IP addresses it doles out. Furthermore, at law enforcement computer crime agencies, spammers are lower in priority than kiddie porn operators and identity theft rings. Recently, a spammer was arrested for opening Earthlink accounts with stolen credit card numbers, but no resolution of that case has happened as of now, and that is the only known case of prosecution of a spammer as of the time of the Newsweek article.

Private action against spammers has not been effective either. For example, for the past five years, Alan Ralsky has used email to pitch diet pills, hair tonic and other sundries, working mostly from networks in China. Anti-spam vigilante groups constantly have tried to convince these networks to kick him off, but when they do, he simply switches to another Chinese company. Ralsky spent 70 hours over 4 days doing just that in November of 2003.

Verizon tried to stop Ralsky for good in 2001, suing him twice in Virginia for 37 million dollars for twice paralyzing the Verizon network with junk email. Last year, after mounting legal bills on both sides, the parties agreed to settle the case. Ralsky paid an undisclosed sum and only promised to stop spamming Verizon customers leaving him free to resume spamming other networks. Other civil suits have led to large judgments, but spammers rarely pay them and survive with operations intact since if they resume operations outside the U.S., they cannot be touched by U.S. courts to enforce the judgments and only assets in the U.S. can be reached.

ISPs are still committed to the courtroom and are continuing to pursue lawsuits in an attempt to scare spammers out of business. However, the outlook is not promising.

Another possible solution is a new federal get-tough-on-spam law. The problem is that not everybody concerned with the issue can agree what spam is. Companies like Microsoft think the internet should be open to send advertisements to everyone who has used their products in the past. That is just about everybody with a computer. Through organizations like Direct Marketing Association, Microsoft and others have lobbied legislators against more stringent measures which would allow individual computer users to sue bulk emailers, and which would limit spammers from sending messages to anyone who did not consent to receive them.

The result of these lobbying efforts is a bill called the CAN-Spam Act, which recently passed the Senate with a 97-0 vote, and is awaiting a vote in the House. It would enforce certain etiquette (emailers must be truthful in subject lines and must honor remove requests) and lay the groundwork for a “Do not Spam” list similar to the “Do not Call” list. It would also allow ISPs, states and the Federal Trade Commission to sue spammers. The problem with a “Do not Spam” list is that the spammers cannot have access to it as only the government will have the list. One might ask then how does one enforce the list if the spammers do not know who they cannot spam. The answer is that the government will sell the list. Therefore, if spammers do get access to the list by buying it (and they are at their peril if they do not buy the list), they then have a list of valid email addresses upon which to base their operations and they then must be sued or arrested to enforce the list.

These are major reasons why the Do not Spam list will not work any better than private litigation. Many of the spammers work from servers which are offshore and beyond the jurisdiction of U.S. courts. Further, it is hard to find them since they hide their true addresses.

Almost everybody familiar with the spam problem and the CAN-Spam Act believes that the act will do little if any good. Some believe that the act lays too much responsibility at the doorstep of the already overworked Federal Trade Commission. Some believe that spam will increase after the government blesses commercial email and the big companies like Microsoft crank up their own advertising by email servers.

The basic problem with filtering and most other prior art approaches to controlling spam is that they put the cost of dealing with spam on the receiver of the spam or the ISPs. Filtering software is an expense and even when the filter is provided by the ISP, the receiver still needs to go through the suspect email folder and spend time making sure no legitimate messages they want to receive are in the suspect email folder.

Some new approaches are starting to appear. Some believe that the spam problem may only be solved by changing the architecture of email itself by revising the code for delivering mail so that ISPs can check whether incoming email is faking its origin. Such changes would take years to trickle down to every network on the internet around the world.

Challenge/response systems offer some relief. These systems let users send email only to people who have the user's email address in their address book. When a user emails a stranger, the recipient's computer sends back a puzzle that only a human and not an automated spam program can solve. If the sender gives the correct response, the email goes through. Typically, these systems work as follows. If an unknown person sends an email to you, he is directed to a website and asked to type in a displayed number. Computer generated spam programs cannot do this.

Another system called micropayments, would charge a tiny amount for each email sent and would add up to large sums only for bulk email spammers and effectively block them. The micropayment approach conflict with the original open and free-of-charge spirit of the internet, but ultimately, it is among the few reliable ways to foil out-of-control spammers and fraud artists. One way of getting around the “its not free” problem with micropayments is to allow each email user to maintain a “white list”. Any other correspondent who is on a white list of a particular user may send email to that user for free. However, white lists still have problems because they are not kept up to date by their users and they give the user just one more thing to do in a world where almost everybody is already too busy to want to bother with maintaining their white list. Even if a user does maintain the white list, there is still a problem of legitimate users who are not on a recipient's white list and who the recipient might not even know such as persons who see an advertisement for the business of the recipient and want to contact the recipient by email. If potential customers have to pay to send email to a business, they may go elsewhere.

One micropayments approach was proposed by Van Alstyne of the University of Michigan and which was presented at the MIT spam conference on Jan. 15, 2004. The Van Alstyne approach is a filter which puts a price tag on incoming email. Email senders set a prices the would be willing to pay for email recipients to read their missive: anything from, say, $2 to a penny. Recipients set a monetary filter for email they are willing to receive. Messages with postage above that which a recipient has set in his filter get through, and recipients can claim the reward. Of course, the higher the filter price, the less spam they will receive. This restores control to the individual—the recipient can set a low threshold and get paid for reading the email or set a high threshold and receive few if any spam messages. Users can set up a “trusted” list and senders on the trusted list can send email free of payments. No evidence of a secure centralized server to process the stemps and assist the recipient in decrypting them is present in this idea.

Tracking down spammers is difficult even if one wishes to sue a spammer. Spammers hide their identities by forging information in email headers making it seem like the spam is coming from a legitimate source. Antispam software can cross-check the forced address with additional information in the message to determine if the message is real. However, as noted above, sometimes virus attacks still get through filtering software masquerading as a legitimate message.

Content filtering based on key words like viagra does not work because spammers change the spelling such that humans still recognize the word but computers do not. For example, viagra will be spelled v*i*a*g*r*a.

Traffic watching software can spot spam if the text has been altered by finding that it is bulk email sent to multiple people. Each email has a digital ID. This ID is compared with other emails on a computer network. If the same ID shows up in several places on a network, the message is deemed to be spam.

Most of these approaches in the prior art put the burden of spam on the recipients or ISPs. This is not where it should be. Therefore, a need has arisen for a system and process to effectively block spam without filtering out desired, legitimate email even from persons who the recipient does not know. Such a system should use the micropayments approach and automate as much as possible the process of maintaining a white list.

### BRIEF DESCRIPTION OF THE DRAWINGS

FIG. 1 is a diagram of the proposed architecture of a system to implement micropayments for email to effectively block spammers who send out large volumes of unsolicited email.

FIG. 2 (comprised of FIGS. 2A, 2B and 2C) is a flow diagram of an overview of the overall email micropayments protocol for the interactions between the sender computer and the receiver computer and the micropayments server, and processing by the the sender process and the receiver process for messages which contain stemps and messages which do not contain stemps. FIG. 2 represents a class of species which use a white list, each species having different characteristics regarding what happens if a no stemp message arrives.

FIG. 3 is a flowchart of processing by the recipient computer and micropayment server for a first species of the protocol carried out when a no stemp message is received and no white list is used.

FIG. 4 is a flowchart of another species or embodiment of a protocol carried out between the recipient computer and the server when a no stemp email arrives which features a challenge-response mechanism to ensure that the sender is not a spammer's computer.

FIG. 5 is a flowchart of first and second species of a protocol carried out between a recipient computer and the micropayment server when an email with an encrypted stemp is received where the same key is used every time to decrypt the stemp and the decryption of the stemp is done by the recipient computer. The two different species differ in where the single key is generated and how the recipient computer obtains it.

FIG. 6 is a flowchart of third and fourth species of a protocol carried out between a recipient computer and the micropayment server when an email with an encrypted stemp is received where the same key is used every time to decrypt the stemp and the decryption of the stemp is done by the recipient computer. The two different species differ in where the single key is generated and how the recipient computer obtains it. The difference over the embodiment of FIG. 5 is that the recipient computer does the decryption and sends the decrypted postage amount to the micropayment server for comparison to a threshold, if any, for the recipient.

FIG. 7 is a flowchart of fifth and sixth species of a protocol carried out between a recipient computer and the micropayment server when an email with an encrypted stemp is received where the same key is used every time to decrypt the stemp and the decryption of the stemp is done by the micropayment server. The two different species differ in where the single key is generated and how the recipient computer obtains it. The difference over the embodiment of FIG. 6 is that the micropayment server does the decryption and the micropayment server does the comparison of the decrypted postage to a threshold, if any, for the recipient. In some embodiments, after the decryption of the stemp, the server sends the decrypted stemp back to the recipient. In other embodiments, after the decryption, the server compares the value of the stemp to the required postage amount and sends back an OK or not OK message to the recipient computer. In other embodiments, the server does the comparison to a threshold postage amount the server maintains for this recipient computer and sends back an OK or not OK message. In other embodiments, the threshold looked up is variable and is based upon both the recipient computer ID and the ID of the sender, with the threshold amounts established by the user. In some embodiments, the server communicates with the recipient computer after the stemp is decrypted to say in effect, “Here is how much postage the sender included. What threshold amount do you want to establish to receive email from this particular sender?” If the amount is not adequate according to the reply from the recipient computer, the server sends back a message to the sender computer saying, in effect, “The recipient requires x.xx in postage to receive a message from you. Do you want to increase your micropayment amount and re-send this message?” If the sender indicates she wishes to increase the micropayment amount, the server authenticates the sender, checks her balance, debits the increased amount and sends back an encrypted stemp for the proper amount for inclusion in the resent message. In other embodiments, after the sender says, OK, I will increase the micropayment amount, the server authenticates the sender, checks the sender balance in their account, deducts the additional postage if the balance is adequate, and sends a message to the recipient computer that the additional amount has been paid and the message is OK to view.

FIG. 8 (comprised of FIGS. 8A and 8B) is a flowchart of seventh and eighth species of a protocol carried out between a recipient computer and the micropayment server when an email with an encrypted stemp is received where the same key is used every time to decrypt the stemp and the decryption of the stemp is done by the micropayment server. The two different species differ in where the single key is generated and how the recipient computer obtains it. The difference over the embodiment of FIG. 7 is that the micropayment server does a challenge-response protocol if the postage is inadequate.

FIG. 9 is a flowchart showing the alternative embodiment of the protocol of FIG. 3 where a pop up question as to whether the user wants to add the sender to a white list is used.

FIG. 10 is a flowchart of a protocol for interaction between the recipient computer, the server and the sender computer when a no stemp message is received which involves a pop up question as to whether the recipient wants to add the sender to a white list and which involves variable thresholds and requests to subscribe to senders who send emails with no stemps.

FIG. 11, comprised of FIGS. 11A and 11B is a flowchart of an alternative embodiment of the protocol of FIG. 3 wherein other users or a sender of commercial email can transfer value into a receiver's postage account or to another person's account such as a charity.

### SUMMARY OF INVENTION

The Receiver Process Genus

This genus is defined by two common characteristics: (1) all species will sense the presence of a stemp; and (2) all species determine if the postage encoded in the stemp is adequate either locally or by communication with a micropayments server; (3) all species allow the message to be viewed if the postage is adequate.

The Sender Process Genus

The genus of the sender process (a process separate from the normal email client which sends and receives email but which works with the email client or is integrated into it to carry out the micropayments protocol) is defined by the following common characteristics: (1) all species must have the ability to request an encrypted stemp from a micropayments server; (2) all species must have the ability to receive back a message from the micropayments server with an encrypted stemp and place the encrypted stemp somehow in the email to be sent in a way which will not interfere with normal processing of the packets in the internet or by the receiver process other than to block the email in predetermined circumstances defined herein.

The Micropayments Server Process

The genus of the micropayments server process is defined by the following characteristics: (1) all species must be able to communicate with potential subscribers to set up postage accounts and/or affinity donation accounts; (2) all species must be able to communicate with sender processes to receive requests for stemps, authenticate the sender process, check for an account and sufficient account balance, and send back an encrypted stemp, debit the account balance, and know the key used to encrypt the stemp for each particular email; (3) all species must be able to communicate with receiver processes so as to assist the receiver process to block spam or extract payments to view the email, the payments to be deposited into the recipients account or an account of an affinity entity such as a charity. This can be done in a variety of ways disclosed above and equivalent ways such as: carrying out a challenge-response protocol with the sender process and sending a message to the recipient computer telling it if the challenge is not responded to or not responded to correctly; inviting the sender to subscribe to a micropayments account and send a message to the recipient computer if the subscription is not entered; and/or maintain a white list for each recipient.

### DETAILED DESCRIPTION OF THE PREFERRED AND ALTERNATIVE EMBODIMENTS

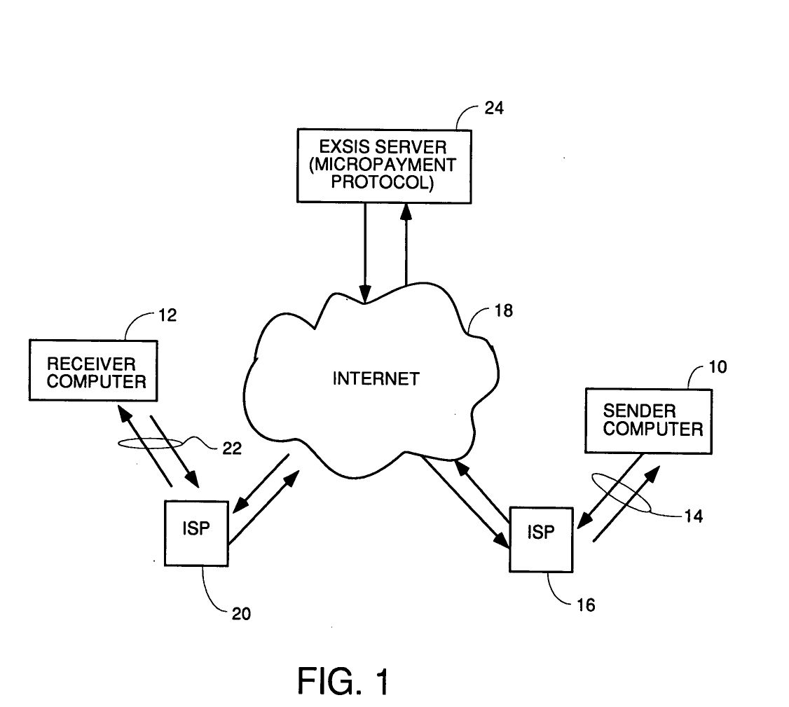

Referring to FIG. 1, there is shown a diagram of the proposed architecture of a system to implement micropayments for email to effectively block spammers who send out large volumes of unsolicited email. A sender computer 10 may be the computer of a spammer or that of a legitimate user who wants to send email to the computer 12 of a recipient. The sender uses whatever internet connection 14 he or she has to the sender's Internet Service Provider (ISP) 14. The ISP routes email packets according to a micropayments protocol through data paths on the internet 18 to a receiver computer's ISP 20 which routes them to the receiver computer 12 via whatever data path 22 connects the receiver computer to the ISP 20. Both the receiver computer and the sender computer 10 interact with a micropayments server 24 through their respective ISPs. The server 24 implements a micropayments protocol to be described below which blocks the email unless it has postage encoded in the packets thereof.

Some embodiments do not use a server 24 and simply rely upon sending and receiving software in each computer 10 and 12 to implement the micropayments protocol. The problem with this approach is that every sender is also a receiver so spammers will receive the receiving process software and be able to decompile the program that implements the micropayments protocol and figure out a way around it. By using a server 24, the computer and software that gates the email messages based upon the presence or absence of micropayments is not in the hands of the spammers.

In some embodiments, the server 24 will process the entire email to determine is a micropayment is present and forward the email if a micropayment is present as was done by Critical Path. However, as usage of the system grows, this presents the potential for bottleneck at the server. Therefore, in the preferred embodiment, the server 24 only processes the header portion of email packets to determine if a micropayment is present and gates the email through if a proper micropayment is present. The micropayment server 24 only processes the stamps to implement the protocol, and the email itself is still addressed to the email address of the recipient. Other prior art systems such as that implemented by Critical Path required all email to be addressed to the Critical Path servers. Since everybody already has their domain set up and email address established, the Critical Path approach was not ideal because it required everybody to change their email address to an address on the Critical Path server. This approach also required all emails to be stored on the Critical Path servers. Thus, the Critical Path servers became a bottleneck.

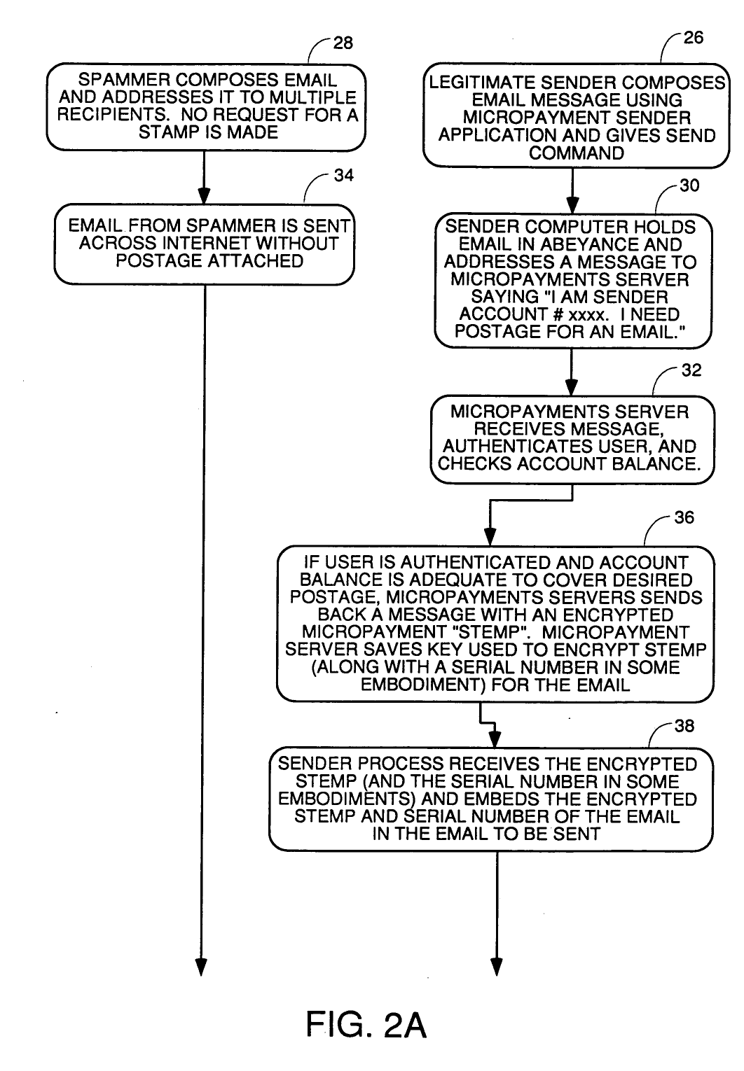

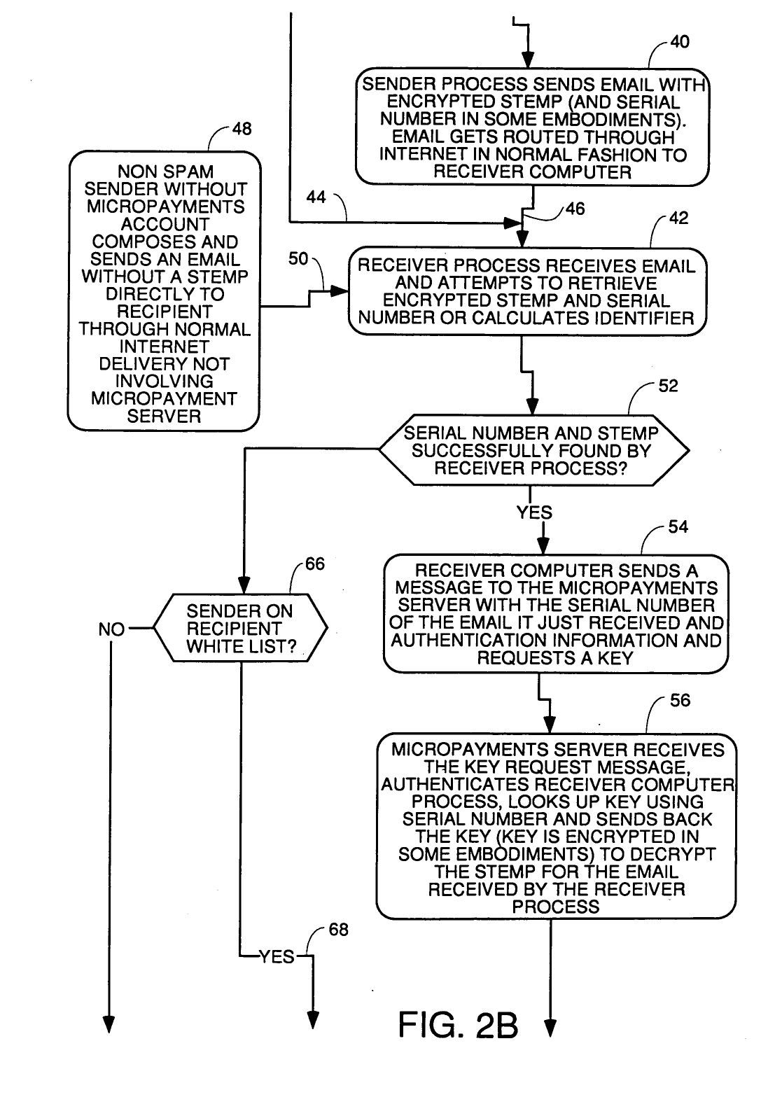

Referring to FIG. 2 (comprised of FIGS. 2A, 2B and 2C), there is shown a flow diagram of an overview of the overall email micropayments protocol for the interactions between the sender computer and the receiver computer and the micropayments server, and processing by the sender process and the receiver process for messages which contain stemps and messages which do not contain stemps. FIG. 2 represents a class of species which use a white list, each species having different characteristics regarding what happens if a no stemp message arrives.

Step 26 represents the process of composing an email for sending to one or a few people by a legitimate sender who has a micropayment account on the server 24. Step 28 represents the process of preparing an email, perhaps with a virus attached, by a spammer with no micropayments account with the intent to send it to millions of people. In step 30, the legitimate sender's computer 10 holds the email addressed to recipient computer 12 in abeyance while it sends a message to server 24. This message is a request for a micropayment stamp, and contains data which says in effect, “I am the computer of sender account #xxxx. I need postage for an email.”

In step 34, the spammer's computer sends the spam email across the internet without attaching any postage.

In step 32, the micropayments server 24 receives the message from the legitimate sender computer 10 and authenticates the user and checks the user's micropayments account balance. Authentication can be by any known means. For example, the micropayments server can verify the domain name of the server from which the message came to verify that it is the correct domain for the user if the user is legitimate. In some embodiments, other elements in the message which get added as the message traverses the internet from the legitimate user's computer 10 to server 24 can be checked (these elements act as a sort of electronic DNA or fingerprint for the message) against known correct elements if the message came from the user the message purports to come from. The simplest and probably the most reliable authentication process is for the server 24 to check for correctness a user name and password that only the legitimate user knows and which is included in the message sent in step 30. If the user name or password do not match store records of the user name and password of the user from whom the message purports to come, the message is rejected as not authentic. Another way of authenticating the message sent in step 30 is to use a public key/private key encryption process with a prior public key exchange between the server 24 and the computer 10 of each legitimate user which has a valid account. In this embodiment, the server 24 sends its public key to each legitimate user. Each user generates a public key and a private key when he sets up an account, and the public key is sent to the server 24. The sender process of sender 10 encrypts the message (or some field therein) sent in step 30 using its private key and the public key of the server 24. This message can only be decrypted with the public key of sender 10 and the private key of the server 24. In step 32, if the micropayments server 24 can successfully decrypt the message sent in step 30, the server 24 knows that the message came from computer 10.

In step 36, the server 24 sends back a message to sender computer 10 that contains an encrypted micropayment “stemp” if the user is authenticated and the account balance is adequate to cover the postage. Each email is assigned a serial number or some kind of identifier, and the key which is used to encrypt the stemp is recorded along with this serial number or identifier. The serial number may be assigned by the server 24 and sent back with the encrypted stemp. The serial number may be the checksum of some critical fields in the header of the email which the micropayment server gets. Likewise, the identifier may be the checksum of certain critical fields of the header or of the main body of the email message, said checksum calculated by the sender process and sent to the micropayments server 24 with the message requesting a stemp. Likewise, the sender process can assign a serial number in any other way that will guarantee the serial number to be unique to this email and send the serial number to the micropayment server.

In step 38, the sender process in computer 10 receives the message with the encrypted stemp (and the serial number or other identifier in embodiments where the micropayments server assigns or calculates the identifier) and writes the encrypted stemp into the email being held in abeyance. The encrypted stemp (and serial number or identifier in some embodiments where the recipient computer does not calculate the identifier from the received email main body or header) are placed in the X-envelope field of the email message header. There is a header in every email that is visible to the recipient computer but not the user of the email client. That is the preferred location for the encrypted stemp. In some embodiments, the encrypted stemp (and serial number or identifier in some embodiments) are placed in user definable fields in the TCP or IP header of the email packets. In some embodiments, the identifier is not sent with the email message but is calculated by the recipient computer receiver process.

In step 40, the sender process of computer 10 send the email with the encrypted stemp (and serial number or identifier in some embodiments) to the recipient computer 12 via the internet in a conventional way. The email packets get routed through the internet routers just like any other email packets. SMTP and POP protocols are unchanged and work in the same way they have always worked.

In step 42, a receiver process running in computer 12 receives the email and attempts to retrieve the encrypted stemp (and serial number or identifer in some embodiments). In other embodiments, the receiver process receives the email and retrieves the encrypted stemp from the message header and then calculates a checksum of the same critical fields of the header or of the main body using the same checksum algorithm as was used by the micropayments server or sender process to calculate the identifier of the message. The incoming email might be from a spammer and have no stemp or serial number, as represented by path 44, or it might be a non spam email sent from a user with a micropayment account, as represented by path 46. A third possibility exists represented by step 48 and path 50. Step 48 represents the process of a non spam sender without a micropayments account composing and sending an email without a stemp. The arrival of this email at the receiver computer 12 is represented by path 50.

Test 52 represents the process of determining whether the email has an encrypted stemp and serial number. If the incoming email does not have a stemp and serial number, it could either be from a spammer, or from a person not on the recipient's white list and not having a micropayments account, or from a person on the recipient's white list and not having a micropayments account, or from a person with a micropayments account.

If the incoming email is from a person with a micropayments account, it will have a stemp and a serial number, and processing will proceed to step 54. There, the receiver computer sends a message to the micropayments server 24 with the serial number or identifier of the email and authentication data for the recipient computer. This message asks for the key to decrypt the stemp. The authentication information can be any information used for any authentication process over the internet known from the prior art as was the case for the authentication of the sender computer 10 by the server 24. In step 56, the micropayment server 24 receives the key request message, authenticates the recipient computer, looks up the key using the serial number in the key request message and sends back the key (encrypted using the public key of the recipient computer in some embodiments) to the recipient computer 12.

In step 56, the receiver process in the recipient computer receives the key reply message, decrypts the key if necessary, and uses the key to decrypt the stemp to ascertain the amount of postage attached to the email.

In step 60, the receiver process determines if the decrypted postage amount is adequate. If so, the receiver process passes the email message to the user's mail client process for viewing, as symbolized by step 62. In alternative embodiments, the amount that the stemp value is compared to is a variable threshold. The threshold value may be programmable by the user in some embodiments, or may be set in a table with the threshold value selected based upon the sender identity. In some embodiments, step 60 compares the sender identity, as established by the sender's email) to the names on a white list of senders who are allowed to send email for free or for very low postage amounts to the recipient and picks the threshold from the threshold value established for the user on the white list.

If the postage is inadequate, the receiver process either deletes the message or sends back a “rejected” message to the sender or saves the message in a folder of the mail client reserved for “questionable-possible spam” messages, as symbolized by step 64. In some embodiments, which of these three things it does is controlled by configuration data that the user can set. In other embodiments, the receiver process does just one of these three things so the list defines three separate alternative embodiments.

Returning to the consideration of step 52, if the email that came in does not have a stemp, it may be from a spammer or it may be from a person on the recipient's white list who does not have an account for micropayments. It may also be from a potential customer who saw the recipient's email address on a website or an advertisement and who chose to contact the recipient by email but who does not have a micropayments account. It may also be from the secretary or some other assistant or friend of a known associate of the recipient, the assistant not being on the white list and not having a micropayments account. If an email comes in which does not have a stemp, step 66 is performed by the receiver process of the recipient computer to determine if the sender is on the white list of the recipient. If the sender is on the white list, processing proceeds along path 68 to step 62 carried out by the recipient computer 12 to pass the email to the email client for viewing on the recipient computer.

In alternative embodiments, step 66 is carried out by the micropayments server 24 which maintains white lists for all users who have established accounts. The advantage of having the white list on the micropayments server is that there is no synchronization problem if the user uses multiple machines to retrieve email such as a desktop machine in the office, another desktop machine at home, and a laptop while on the road. If a user does use multiple machines to retrieve email and the white list is kept on the local machine, all white lists on the multiple machines the user uses should be kept synchronized (all containing the same entries and same threshold stemp values in embodiments where different postage values are used for different users).

Another advantage to maintaining the whitelist for each user on the micropayments server is that the micropayments server could use the white list for each user to act as a filter so that only emails which have proper stemp postage or which are from senders on the recipient's white list are approved for sending by the micropayments server 24.

If the sender is not on the white list of the recipient, processing proceeds to step 70. Step 70 represents processing which can be performed by several different species or embodiments. In one embodiment, configuration data set by the recipient establishes how the recipient computer responds to incoming email without a stemp which is from a sender which is not on the recipient's white list. The recipient can set this configuration data to automatically delete the email or put the email into a questionable-possible spam folder of the email client or carry out a challenge response protocol and pass the email to the email client for viewing if the response comes back correct. The challenge response protocol has the recipient computer send a challenge message back to the recipient which poses a question which only a human can answer. Such a challenge might be “tell me the number which is displayed in the following dot matrix” or “tell me who the first president of the United States was” or “tell me the name of the person displayed on the US five dollar bill”. The question must be something that a human can easily answer but which a spammer's computer would not be able to answer for lack of senses and memory and cognitive ability. If a response comes back which is right, which it would if the sender was a potential customer or somebody the recipient wanted to receive mail from who happens not to be on the recipient's white list, the email is passed to step 62 for viewing.

Step 70 also represents alternative embodiments that do only one of the three listed things. The preferred embodiment would be to just carry out a challenge-response protocol since this would foil spammers but not preclude humans not on the white list and not having a micropayment account from getting their emails through to the recipient.

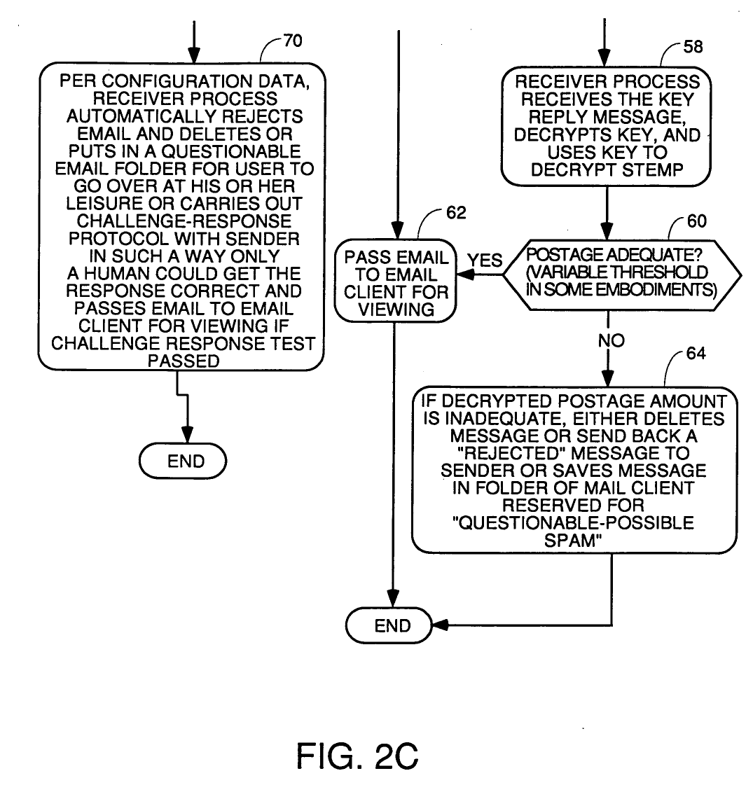

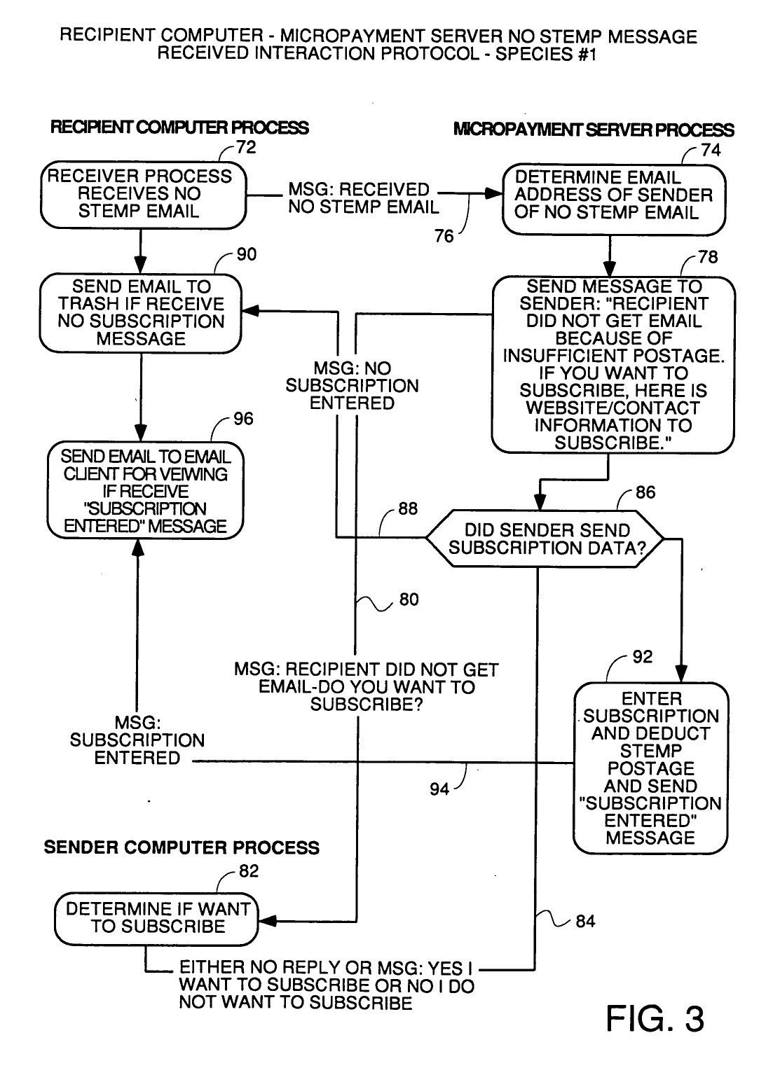

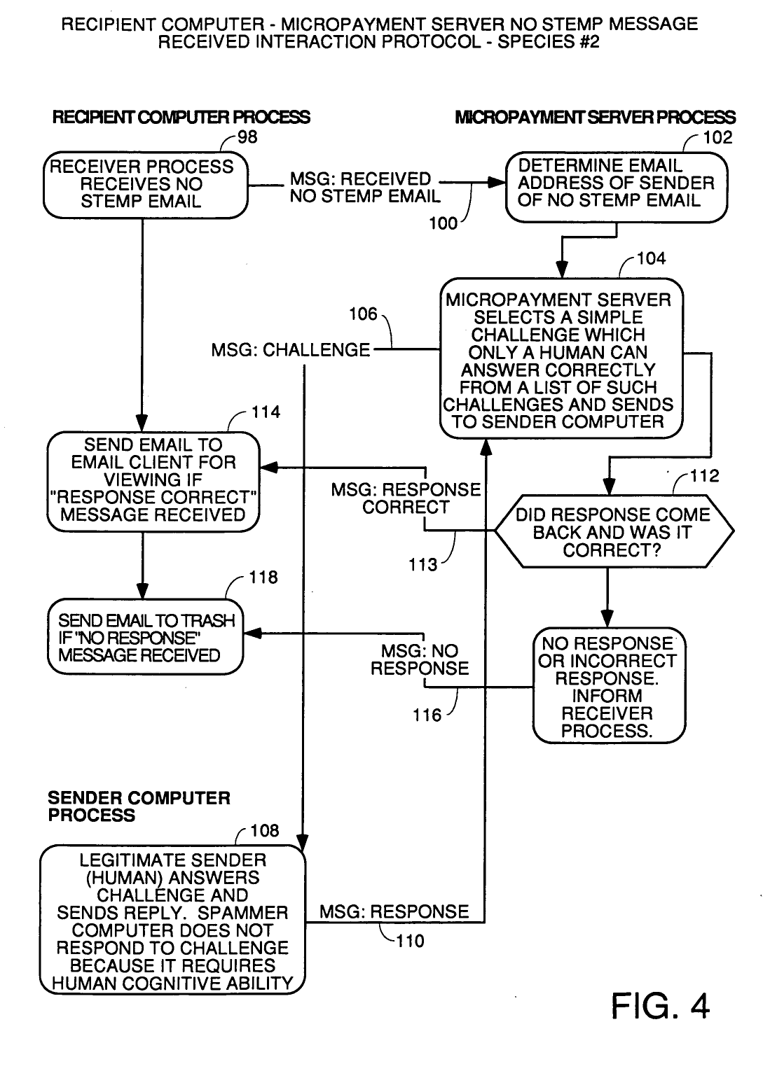

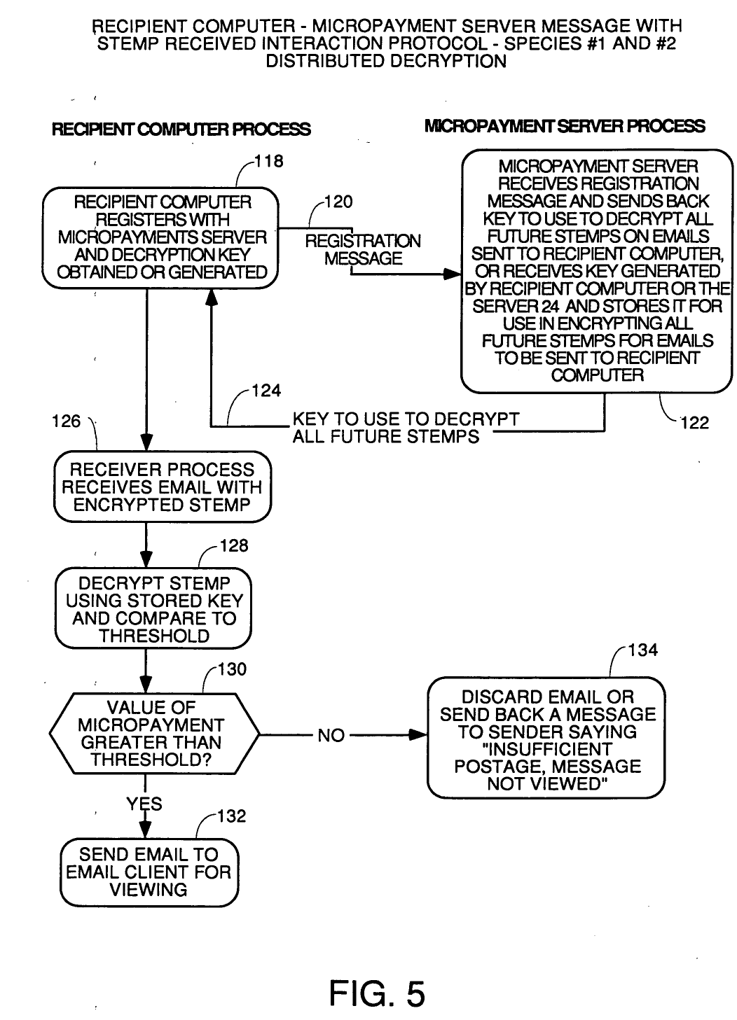

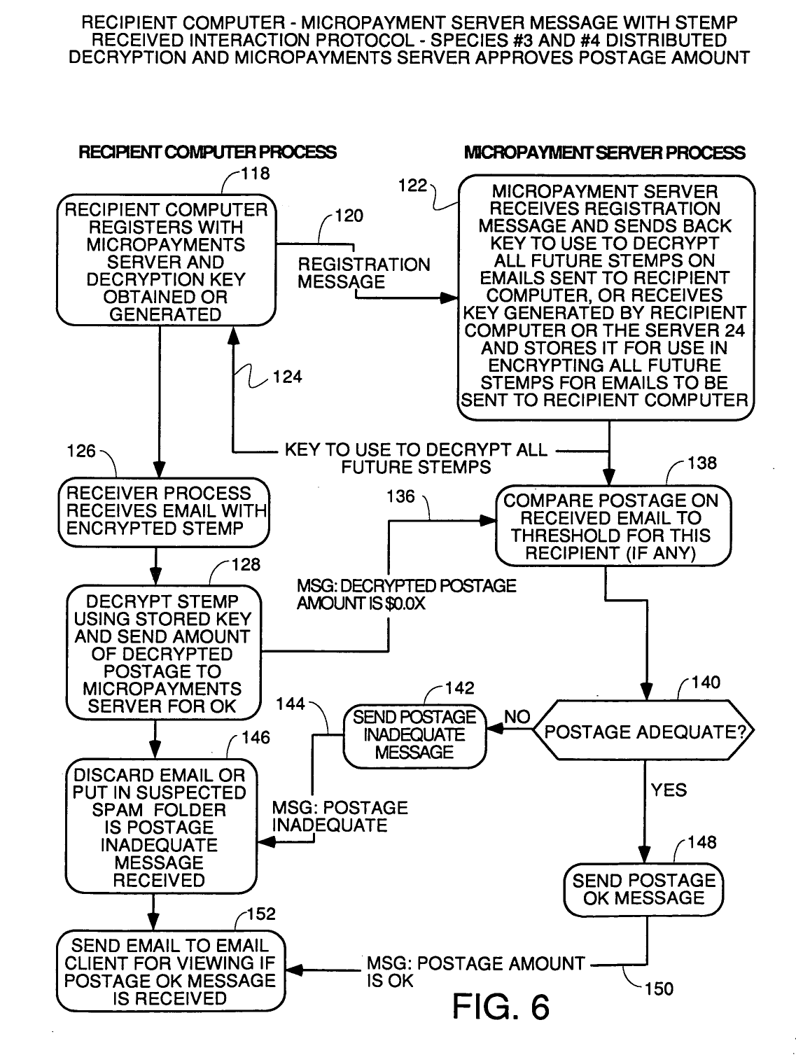

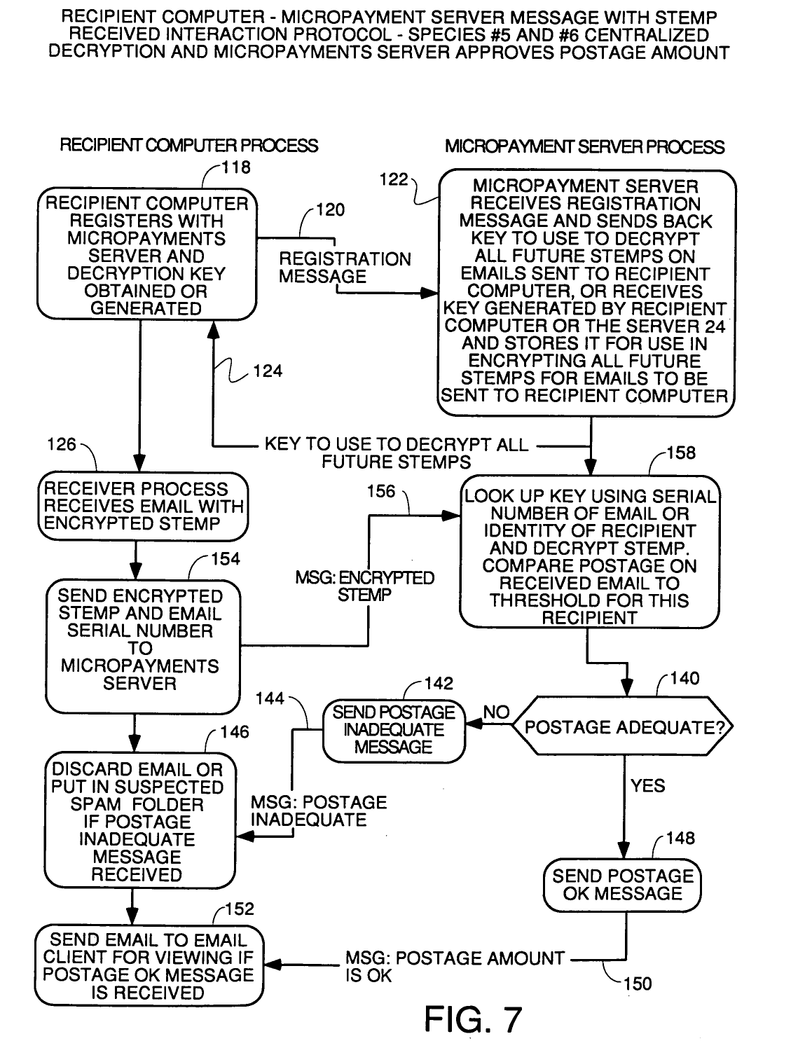

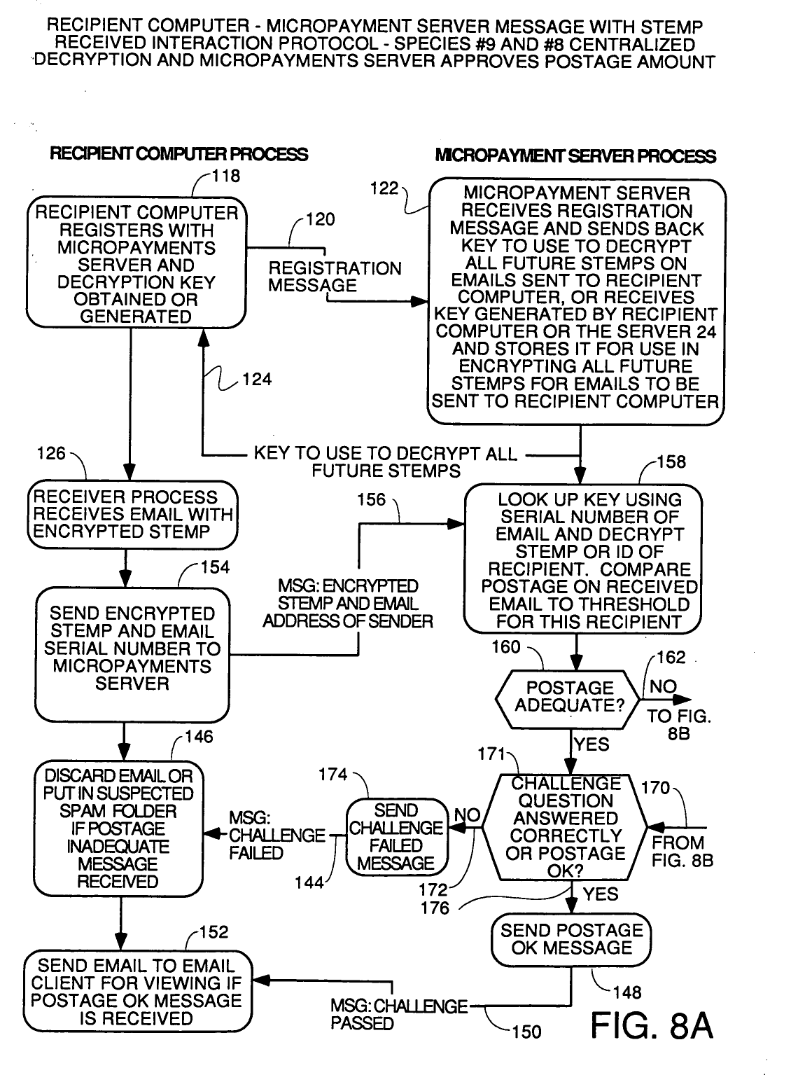

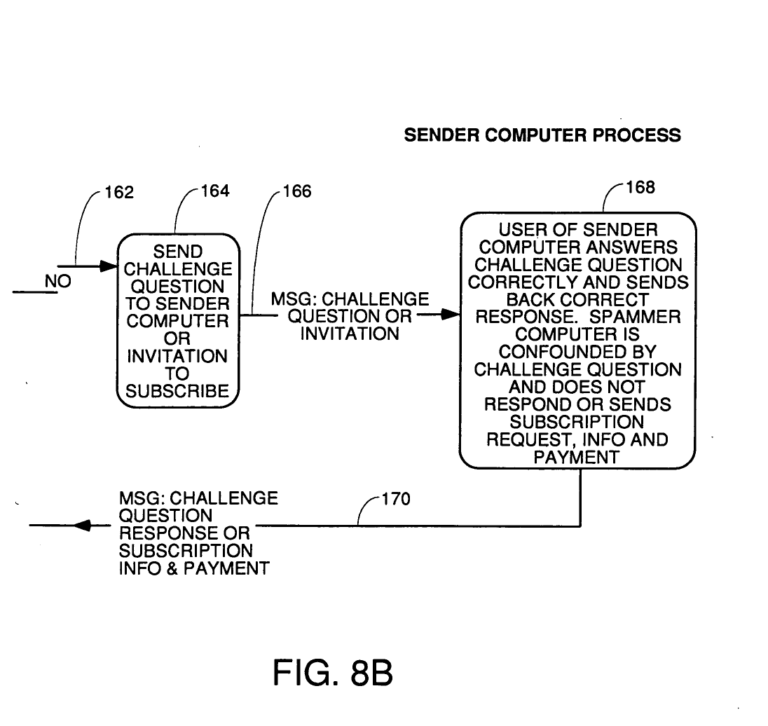

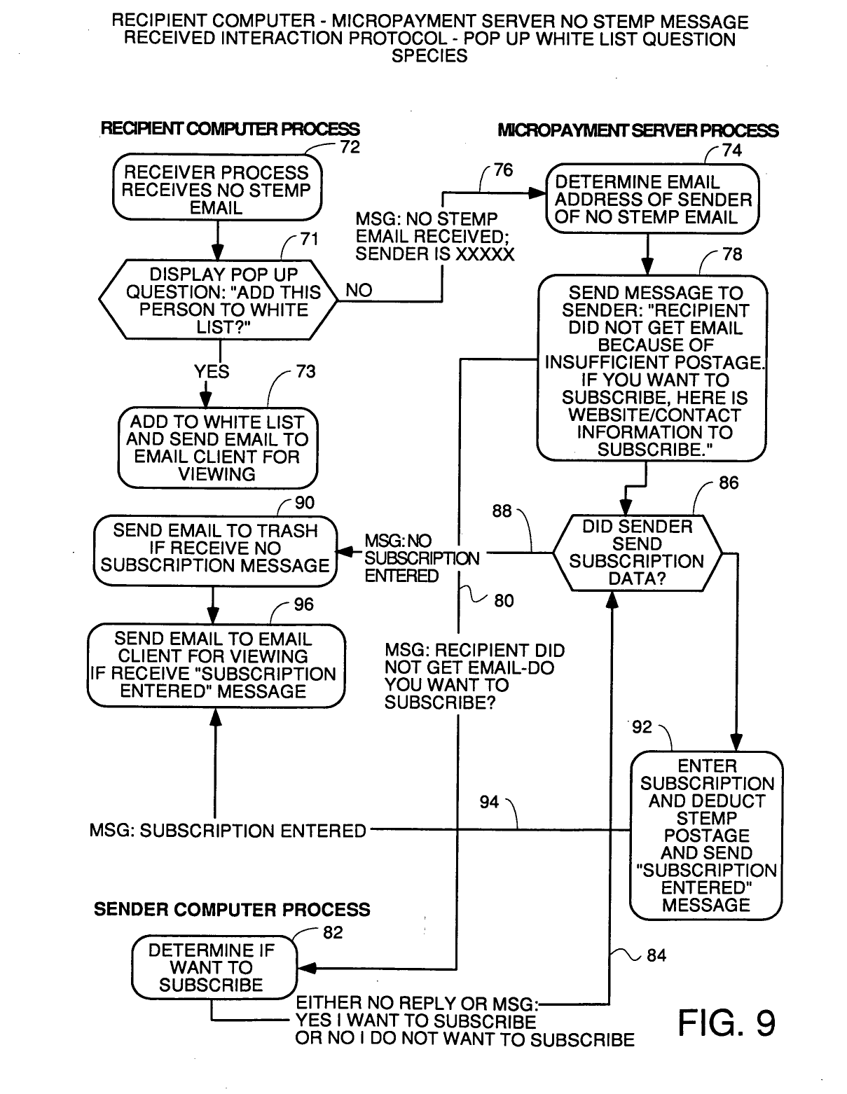

Referring to FIG. 3, there is shown a flowchart of processing by the recipient computer and micropayment server for a first species of the protocol carried out when a no stemp message is received where no white list is used. Step 72 represents the receiver process receiving an email which has no stemp and detecting this fact and responding by sending a message to the micropayments server saying, “I just received a no stemp email”. In an alternative embodiment, step 72 receives an email with no stemp, detects this event and displays a pop up question to the user, “Do you want to add this sender to your white list?”. If the user answers yes, then the sender's email address is automatically added to the recipient's white list and the email is sent to the email client for viewing. In this alternative embodiment, the rest of the process of FIG. 3 is not carried out if the user chooses to add the sender to the white list, but is carried out as shown if the user chooses not to add the sender to the white list. FIG. 9 is a flowchart showing this alternative embodiment. Steps 71 and 73 are new. Step 71 is performed by the recipient process after the no stemp email is received to display the pop up “add to white list?” question. If the answer is no, a message is sent to the server 24 indicating a no stemp email has been received. If the answer is yes, step 73 is performed to send the email to the email client for viewing. This pop up white list question is also an alternative embodiment to the embodiment of FIG. 2 (step 54 altered to only send the message to the micropayments server if the user answers no to the “add to white list?” question). The pop up white list question is also an alternative embodiment to each of FIGS. 4, 5, 6, 7 and 8. In the embodiment of FIG. 4, the modification to the flowchart is the same as in FIG. 3. In the embodiments of FIGS. 5 and 6, a step to display the pop up question is added after step 128 (or step 126 in some alternative embodiments). The sender's address is added automatically to the white list if the answer is yes and the rest of the process is skipped. The recipient computer sends back a message to the sender indicating she has been added to the user's white list and there is no need to use postage in the future when sending email to this recipient. If the answer is no, the rest of the process is carried out as depicted. The same modification is made to the protocol of FIGS. 7 and 8 except the pop up question step is added after step 154 or step 126 in some embodiments.

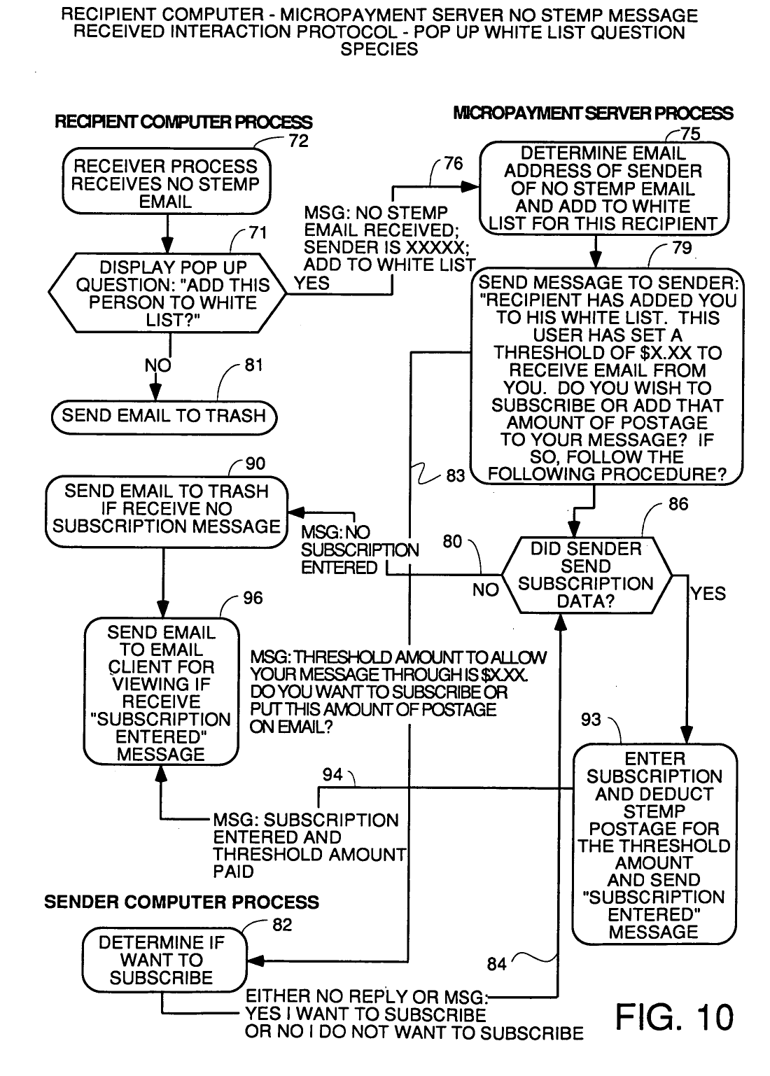

In some alternative embodiments represented by FIG. 10, the white list is maintained by the micropayments server 24 and the server 34 communicates the threshold amount on the white list to the sender process. The embodiment of FIG. 10 is the same as the embodiment of FIG. 9 except for the following changes. If the user answers yes, message 76 is sent to the micropayments server telling it that a no stemp email was received, giving the identity of the sender and asking the micropayments server to add the sender to the recipient's white list. The micropayments server responds in step 75 by determining the email address of the sender and adding the sender to the recipient's white list. The micropayments server will then, in step 79, send a message to the sender computer indicating that the sender has been placed on the recipient's white list and indicate that the recipient has set a threshold amount of $x.xx to receive email from this sender. The user can program the threshold amounts different for every sender or set a zero cents threshold for all white list residents in the class of friends and $1.00 for all white list residents in other classes such as commercial senders of email. The message 83 sent from the server 24 to the sender tells the sender what the amount of postage required is for that sender and asks if the sender wants to subscribe and put that amount of postage on the email. A spammer will not do this, and some senders of messages such as sellers of products a user has bought who wish to send future promotions to the user may also balk at paying a high amount to send an unsolicited message to the recipient. The sender computer then performs step 82 and sends back a response either saying the sender does or does not want to subcribe or sends back no response at all, all symbolized by message 84. The server 24 then performs step 86 to determine if the user sent back a reply or did not reply as would be the case of a spam server. No reply or a negative answer to the subscription question causes message 80 to be sent to the recipient computer which performs step 90 to trash the email. If a subscription was entered, step 93 is performed to enter the subscription, deduct the threshold amount and send a “subscription entered” message 94 to the recipient computer. The recipient computer then sends the email to the email client of the recipient computer for viewing. If the answer to the pop up question posed in step 71 of FIG. 10 is no, the recipient computer receiver process performs step 81 to send the email to the trash.

Returning to the consideration of the protocol of FIG. 3, step 74 represents the processing in the micropayments server to receive this message 76 and determine the sender's email address. This email address is preferably in the message represented by line 76 or it may be obtained by an exchange between the server 24 and the recipient computer 12. The server responds in step 78 by sending a message 80 to the sender saying, “The recipient did not get your email because it did not have any postage on it. Do you want to establish a micropayments account to avoid having this happen again in the future?”

The sender computer responds in step 82 by either doing nothing or by sending back a reply which may say the sender does want to establish an account or does not want to establish an account, all possibilities being represented by line 84.

The micropayments server responds in step 86 by determining if the sender sent a message indicating a desire to establish an account or indicating no desire to establish an account or if the sender did not respond to message 80 at all. If the sender did not respond or indicated no desire to establish an account, the server sends message 88 telling the recipient computer receiver process to send the no stemp email to the trash, as represented by step 90. If test 86 determines that the sender indicated he or she does want to establish an account, then the server carries out step 92 to enter a subscription and deduct the amount of the stemp postage and send a “subscription entered message” 94 to the recipient computer.

The recipient computer responds in step 96 by sending the email to the email client of the recipient computer for viewing.

FIG. 4 is a flowchart of another species or embodiment of a protocol carried out between the recipient computer and the server when a no stemp email arrives which features a challenge-response mechanism to ensure that the sender is not a spammer's computer. No white list is used in this embodiment as was the case for the embodiment of FIG. 3. In step 98, the recipient computer 12 receives a no stemp email message. It responds by sending message 100 to the micropayment server 24 saying it received a no stemp email. Preferably, message 100 contains the email address of the sender so that the server 24 does not have to carry out an exchange with the receiver computer 12 to determine the sender's email address. But in other embodiments, the server 24 can send a message to the recipient computer asking it for the sender's email address. The determination of the sender's email address by server 24 is represented by step 102.

In step 104, server 24 selects a simple challenge question which only a human can answer from a list of challenge questions stored in the server. The server 24 preferably does not send the same challenge every time. All the challenges are easy such as “type the number displayed in the following dot matrix display?”, or “Who was the first president of the U.S?” (that one might not be so easy for foreigners), or “What is the denomination of the smallest paper money bill the U.S. treasury issues?”, or “What is the first name of the patriarch of the cartoon Simpson family?” Since survey evidence proves that Bart Simpson is the most famous American worldwide, that question should work well overseas. This challenge question is then sent in a message to the email address of the sender, as represented by message 106.

The sender computer's receiver process (if it has one—available free for download from the assignee of the present invention) receives the challenge message and recognizes it as a challenge message from unique information in the message body or in the header that labels the message as a challenge, as represented by step 108. The receiver process then displays the challenge to the user of the sender computer. If the sender computer is a spammer's server, no human will ever see the challenge, and no response will be issued. The spammer's server will not be able to automatically respond to the challenge because the challenge requires human cognitive ability. If the sender computer's operator is a legitimate non-spammer person, the human operator will see the challenge, answer it and give the send reply command. A response message 110 will then be sent back to the server 24 with the answer to the challenge question. No message 110 results if the sender computer is a spam server.

The server 24 monitors for a response message 110 as symbolized by step 112. If step 112 determines that a response came back to the challenge message and the response was correct, it sends a “response correct” message 112 to the recipient computer 12. Receipt of the “response correct” message causes the recipient computer to carry out step 114 to send the email in question to the email client of the recipient computer for viewing.

If step 112 determines that no response came back from the sender to the challenge message, or that the response that came back was incorrect, message 116 is sent to the recipient computer saying “no correct response received”. Receipt of the “no correct response received” message causes the recipient computer to carry out step 118 to send the email in question to the trash automatically before the email client ever receives it. In alternative embodiments, the email message may be stored in a “suspected spam” folder for the email client.

In the processes of FIGS. 2, 3 and 4 and the other flowcharts given herein, each message from the server computer to the recipient computer or sender computer or vice versa can be authenticated in any known way such as user name and password or encrypted using a secret key that only the intended recipient has so as to prevent spoofing either the server or the sender computer or the recipient computer by a hacker or spammer. These authentication processes are not specifically detailed in the flowcharts but are present in the preferred species of each class of embodiments.

FIG. 5 is a flowchart of one class of protocols for distributed decryption of stemps by the recipient computers which are carried out when a recipient computer receives an email with a stemp. One embodiment within this class of protocols is shown in FIG. 2, steps 42, 52, 54, 56, 58, 60, 62, 64, 66 and 70. In that embodiment, the recipient computer received an email message with an encrypted stemp and then asked the micropayments server for a key. But there are other possibilities, and FIG. 5 is one of them. In the embodiment of FIG. 5, the recipient computer does the decryption of the email stemp on every received email using the same key every time. There are several alternative embodiments for how this key is obtained. In the first species, the recipient computer registers with the micropayments server and the micropayment server acknowledges the registration and sends back a key to be used to decrypt all future emails with encrypted stemps received by the recipient computer. This registration can be performed every time at power up or one time only when the user of the recipient computer establishes an account with the micropayment server. In the second species, the recipient computer generates a key to be used for decrypting stemps of all emails received by the recipient computer and sends that key to the micropayments server. Both species are represented by steps 118 and 122 and messages 120 and 124 in FIG. 5. In the first species, step 118 represents the recipient computer sending a registration message 120 and receiving back in message 124 the key to be used to decrypt the stemp in every future email. The recipient computer then stores that key. In step 118, representing the second species, the recipient computer generates the key it will use to decrypt all stemps and sends it to micropayments server 122 in the registration message 120. A third species involves the server computer receiving a registration message from a recipient and generating a key which will be used to decrypt all stemps in emails sent to that recipient and saving that key in a database on the server. The recipient then sends copies of the encrypted stemps to the server which decrypts them and sends back a message as to whether the micropayment is or is not sufficient. All of these species can be implemented in the embodiments of FIGS. 3 through 11 and differ from the species in FIG. 2 in that the same key is used all the time by the recipient computer instead of requiring a message requesting a key to be sent to the server 24 each time an email with a stemp is received. This cuts down on message traffic and cuts the workload of the micropayments server 24.

Step 126 represents the process of the recipient computer receiving an email with an encrypted stemp. In step 128, the recipient computer decrypts the stemp with the stored key and compares the value of the postage to a threshold value. Step 130 vectors processing to the appropriate routine based upon the comparison in step 128 of the postage to the threshold value. If the postage is equal to or more than the threshold value, the email is sent to the email client for viewing in step 132. If the postage is inadequate, the email is discarded without viewing or a message is sent back to the sender saying insufficient postage, as represented by step 134. Sending back a message to the sender is not preferred since that gives a potential spammer information that the email address is valid. Step 134 represents two different subspecies within each of the species represented by steps 118, 122 and messages 120 and 124.

FIG. 6 is a flowchart of a class of protocols like FIG. 5 in that they use distributed decryption with the same key all the time but sending the amount of the decrypted postage to the micropayments server for approval. In alternative embodiments, the processing of FIG. 6 can be altered to use the process of FIG. 2 to retrieve a key from the micropayments server each time a stemped email is received. Steps 118, 122 and 126 are the same as described in FIG. 5 as are messages 120 and 124. Step 128 is different. In step 128, the encrypted stemp is decrypted with the stored key, and the decrypted amount is sent to the server 24 in message 136. The micropayments server compares the postage amount in message 136 to the threshold amount (programmable by recipient in some species—the recipient may not have any threshold at all or may set a high threshold for some senders and a lower threshold for everybody else) in step 138. Step 140 in the server 124 then vectors process to the appropriate message sending process depending upon the results of the comparison. If the postage is inadequate, processing is vectored to a process 142 to generate and send a postage inadequate message 144 to the receiver process in the recipient computer. This causes the receiver process to carry out step 146 to discard the email or put it in a suspected spam folder for viewing the email client.

If the amount of the postage is adequate, processing is vectored to process 148 to generate and send a “postage OK” message 150 to the receiver process. This causes the receiver process to carry out step 152 to send the email to the email client for viewing.

FIG. 7 is a flowchart of fifth and sixth species of a protocol carried out between a recipient computer and the micropayment server when an email with an encrypted stemp is received where the same key is used every time to decrypt the stemp and the decryption of the stemp is done by the micropayment server. The two different species differ in where the single key is generated and how the recipient computer obtains it. In this regard, the protocol of FIG. 7 is identical in its two species as the two species represented by FIG. 6. Therefore, steps 118, 122 and 126 and messages 120 and 124 are identical as the like numbered steps in FIG. 6. Likewise, steps 140, 142, 146, 148 and 152 are identical as are messages 144 and 150 to the like numbered steps and messages in the protocol of FIG. 6.

The difference in the protocol of FIG. 7 over the embodiment of FIG. 6 is that the micropayment server does the decryption of the stemp, and the micropayment server does the comparison of the decrypted postage to a threshold, if any, for the recipient. Therefore, a new step 154 to send the encrypted stemp from the received email and the serial number of the email to the micropayment server as message 156. The micropayment server 158 then looks up the serial number of the email and decrypts the stemp. The micropayment server then compares the amount of the postage to the threshold, if any, for the recipient. Step 140 then determines if the postage is adequate, and vectors processing to step 142 if it is inadequate and step 148 if it is adequate, to send appropriate messages to the recipient computer, as was the case for FIG. 6. Steps 146 and 152 carried out by the recipient computer in response to these messages is identical to the embodiment of FIG. 6.

FIG. 8 is a flowchart of seventh and eighth species of a protocol carried out between a recipient computer and the micropayment server when an email with an encrypted stemp is received where the same key is used every time to decrypt the stemp and the decryption of the stemp is done by the micropayment server. The two different species differ in where the single key is generated and how the recipient computer obtains it. The difference over the embodiment of FIG. 7 is that the micropayment server does a challenge-response protocol if the postage is inadequate. Steps 118, 122, 126, 154, 158, 146 and 152 and messages 120, 124 and 156 are the same as like numbered steps and messages in FIG. 7. The difference starts at step 160 which the micropayment server performs to determine if the postage decrypted in step 158 is adequate. If the postage is not adequate, processing is vectored on path 162 to step 164 where the micropayment server picks or generates a challenge question that only a human can answer and/or generates a message which invites the sender of the email to subscribe to a micropayment account. In alternative embodiments, step 164 will only generate a challenge question or only send an invitation message. Message 166 represents transmission of a message which contains the challenge question and/or invitation (depending upon the species) to the sender computer's receiver process, represented by step 168. In step 168, the user of the sender computer either answers the challenge question or sends back a message with information requesting a subscription, or both. A series of messages to complete the registration may follow in embodiments with an invitation. The response message or subscription request is represented by message 170. If the sender computer is a spam server, no message 170 will result as the spam computer will not be able to answer the challenge question and will not want to subscribe because of the volume of spam it generates. Step 171 represents the process carried out by the micropayment server to determine if the challenge response is correct in embodiments that use a challenge or if a subscription has been correctly entered for this sender. If the challenge response was incorrect or missing and no subscription was entered, path 172 to step 174 is taken and step 174 is performed. This step sends a challenge failed message 144 to the recipient computer which causes it to perform step 146 to discard the email or put it in a suspected spam folder. If the challenge response was correct and/or a subscription was correctly entered, processing is vectored along path 176 to step 148 to send a postage OK message 150 to the recipient computer. This causes the recipient computer to perform step 152 to send the email to the email client process for viewing.

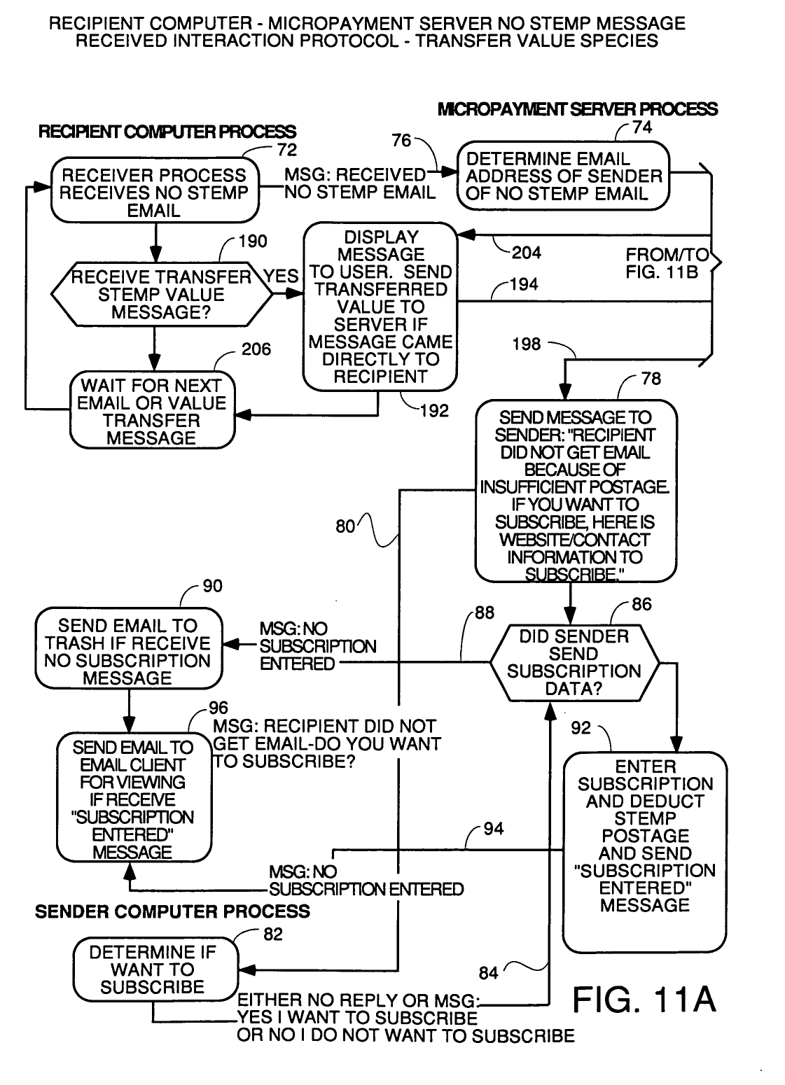

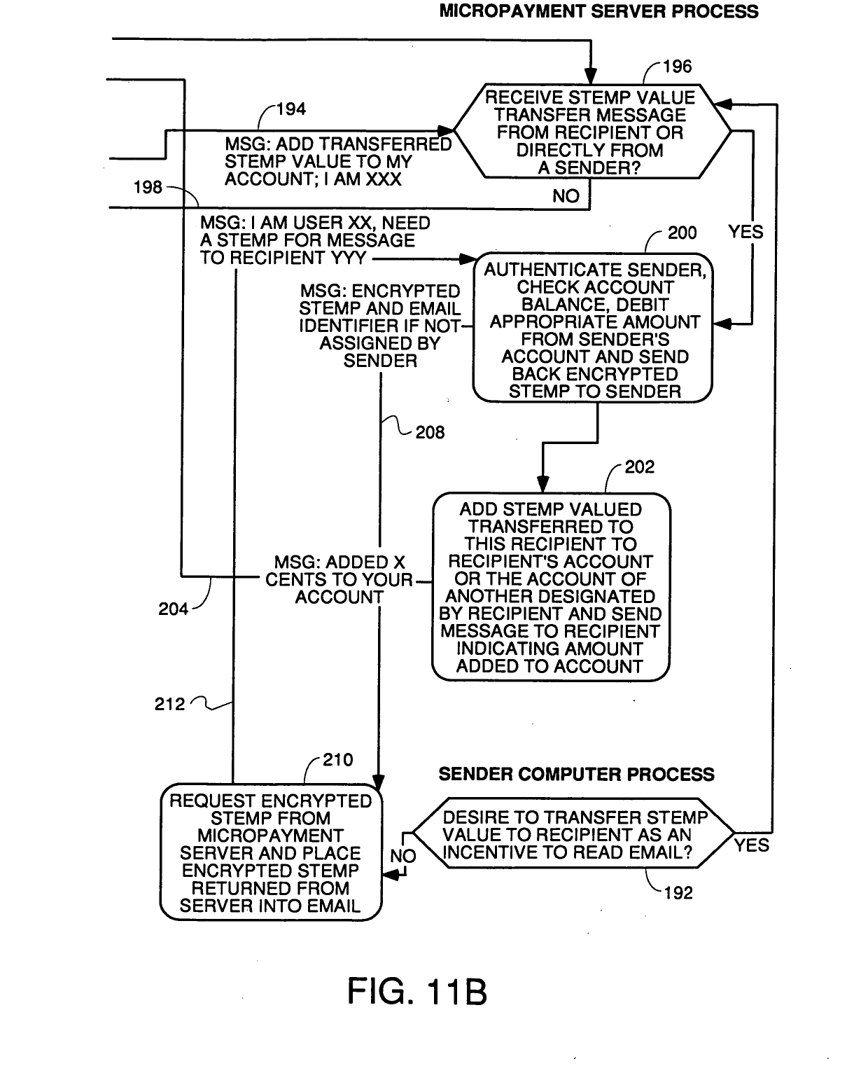

FIG. 11, comprised of FIGS. 11A and 11B, is a flowchart of an alternative embodiment of the protocol of FIG. 3 wherein other users or a sender of commercial email can transfer value into a receiver's postage account or into an account of another such as a charity of the recipient's selection, or, of the sender's selection in some embodiments. Typically, increments of postage will be sold in $10 increments or some other amount which makes commercial sense. Some users may have no need for an amount of postage this large based upon their average email volume, so the embodiment of FIG. 11 allows this type of user to transfer stemp value to other users by sending a message to the other user saying, “I hereby transfer the amount of $x.xx of stemp postage to you.” or “I hereby transfer the amount of $x.xx of stemp postage to you if you do not block my email.” or “I hereby transfer the amount of $x.xx of stemp postage to you if you open this email.”

Step 190 represents a step carried out by the recipient process to determine if an incoming message is a transfer value message. Such messages will be uniquely identified in their headers.

If a recipient receives a value transfer message directly from another user, step 192 is performed on the recipient computer by the receiver process to display a message to the user that sender Mr. xxxxx has just transferred or desires to transfer whatever the amount transferred is to the user's stemp account, or to the account of an entity of the recipient's choosing such as a charity. Step 192 also sends message 194 to the micropayments server requesting that the transferred stemp value be added to the recipient's account, or to the account of another of the recipient's choosing such as a charity, and sending authentication information to the micropayments server so it can identify and authenticate the sender of message 194. The micropayments server determines in step 196 whether a value transfer message has been received.

The server can receive value transfer messages directly from a sender or the value transfer message may be received from a recipient of email who has itself received a value transfer message from the sender indicating the sender wishes to transfer a micropayment amount to the recipient or some other entity designated by the recipient on condition that the recipient not block the sender's email or will at least open the email. The value transfer message preferably also contains enough information to identify and authenticate the sender. This means that if a sender sends a value transfer message directly to a recipient, that sender should also send information with the value transfer message which is adequate to authenticate the sender. This may be implemented by having a value transfer password of the sender which is different than any other password of the sender and which can be used only to authenticate the sender for purposes of transferring a micropayment amount from the sender's account to the recipient's account (or an account designated by the recipient) and cannot be used to obtain encrypted stemps or for any other purpose.

In the case of a value transfer message sent directly to a recipient, the receiver process on the recipient computer will send message 194 to the micropayment server asking the micropayment server to add the micropayment amount to the receipient's account, or the account of another designated by the recipient, on the occurrence of a specified condition such as not blocking the email or opening it. Step 196 is performed after step 74.

If no value transfer message has been received by the server, processing vectors on line 198 to step 78 which is identical to the like numbered step in FIG. 3. Thereafter, the process is identical to the process of FIG. 3.

If step 196 determines that the micropayments server has received a value transfer message, the server executes step 200 to authenticate the sender of the value transfer message (the one who wants to give the money to another user), check the account balance for that sender, debit the appropriate amount from the account if the value transfer message came directly to the server from a sender (a process to be discussed next), and send back an encrypted stemp to the sender if the value transfer message came directly from a sender process (as opposed to a receiver process of a recipient). Then step 202 is performed to add the transferred stemp value to the recipient's stemp account or to the account of another designated by the recipient, and send a message 204 to the receiver process of the recipient indicating the amount of the transferred value. Message 204 causes the recipient's computer in step 192 to display a message to the user indicating how much stemp value has been added to the recipient's account or the account of another designated by recipient on the server and who the donor was. The recipient computer then performs step 206 to wait for the next email or value transfer message and performs step 72 if it receives a no stemp email and step 190 if it receives a transfer stemp value message.

Some senders of commercial email may want to prioritize their email for recipients by giving the user an incentive to read it or just open it and not send it to the trash. This can be done by including with the email some stemp value which gets transferred into the recipient's postage account or somebody else's account on the server and which causes the server to send a message to the recipient saying who donated what amount to which account (message 204 discussed above). For example, tickets.com may want to send an advertisement to its mailing list of customers and may wish to encourage the customers to read it. Suppose, the threshold stemp value to send an email to a recipient is one cent. A user of a Tickets.com server may cause its sender process in step 192 to request a stemp with a special message 194 that requests a stemp, and requests that an excess amount over the required value of the stemp be transferred to the recipient's stemp account. This message 194 contains the regular information needed to authenticate the requester and request an encrypted stemp, but also contains a request to debit some amount from the sender's stemp account which is more than the required value of the stemp and transfer the excess to the recipient's stemp account or to the account of another designated by the recipient. Message 194 is detected by the server in step 196 and causes the server to perform step 200 to authenticate the sender, check the account balance for that sender, debit the amount requested in message 194 from the sender's account, check the threshold amount to send an email to the intended recipient of the message for which the stemp was requested, subtract the threshold amount from the debited amount and supply the difference to step 202, and send back an encrypted stemp (along with an email identifier for the email message the sender wants to send in embodiments where the server assigns the message ID or serial number). This message including the encrypted stemp is represented by line 208 and causes the sender computer in step 210 to include the encrypted stemp and message ID or serial number in the email addressed to the recipient and send the email by normal channels.

After step 200 is performed, step 202 is performed to add the difference value received from step 200 to the intended recipient's stemp account or to the account of another designated by the recipient. Then message 204 is sent to the recipient as previously described which causes the recipient computer to display a message in step 192 indicating how much was added to the recipient's account or to the account of another designated by the recipient and who the donor was.

If the sender elects in step 192 to not transfer value to the recipient, step 210 is performed after step 192. Step 210 sends a request message 212 to the server saying, “I am user xx. I need a stemp for an email to recipient yyy.” This causes the server to execute step 200 to authenticate the sender, check the account balance, debit the amount needed to send an email to this recipient (in some embodiments, there is an exchange of messages to the effect, “This recipient requires a postage amount of $z.zz to receive a message from you. Do you still want to send this message?”), assign an ID for the email (in embodiments where the server assigns the email serial number or identification codes) and send back an encrypted stemp (along with the ID assigned to the email in some embodiments). The encrypted stemp and ID are message 208. This causes the sender process to put the encrypted stemp and ID in the email and send it by normal channels. Receipt of the email with encrypted stemp causes the recipient computer to execute one of the other protocols described herein for receipt of an email with a stemp.

The transfer value functionality described above can be added to any of the other embodiments described herein to generate more species within the overall genus. An important alternative embodiment of the transfer value process involving transfer only if the recipient opens the message is comprised of the following steps:
receiving a white list request message from a recipient computer that an email that has no encrypted stemp has been received, said message also containing data from which said recipient can be identified and authenticated and identifying the sender of said email and including a request to add said sender to a white list maintained for said recipient by said server;
responding to said white list request message by identifying and authenticating said recipient computer using information in said white list request message, and if said recipient computer is authentic, adding the sender to a white list maintained by said server for said recipient, said white list containing a programmable threshold amount each recipient has set to receive email from various senders or classes of senders;
sending a message to said sender indicating the threshold amount said recipient has established to receive email from this sender and inquiring whether the sender would like to establish a micropayments account and pay the threshold amount therefrom to allow the email message to be viewed by the recipient or, if the sender already has a micropayments account, inquiring whether the sender would like to deduct the threshold amount from the sender's micropayment account in order to cause the server to send a message to said recipient that it is permissible to view the email;
determining if the sender does not have a micropayments account and does not establish one or indicates he does not want the threshold amount deducted from his micropayments account, and, if either of these event occurs, sending a message to said recipient computer indicating the email message should not be viewed or placed in a potential spam folder;
if the sender sends back a message indicating he or she would like to have the threshold amount deducted from an already existing micropayment account for this sender or establish a micropayments account and have the threshold amount deducted therefrom, deducting the threshold amount from the sender's already existing micropayment account or establishing a micropayments account for said sender and deducting the threshold amount from said account, as appropriate; and
sending a message to said recipient computer indicating the email can be viewed and indicating how much value will be transferred to the recipient's micropayments account, or the account of another designated by the recipient if the recipient opens the message, and waiting for confirmation that the recipient opened the message;
if a confirmation message is received from said recipient computer which is automatically generated when a recipient opens an email message which indicates the recipient opened said email sent by said sender, authenticating said recipient computer which opened said message using information in said confirmation message, and transferring the amount deducted from sender's micropayments account to said recipient's micropayments account or to the account of another designated by the recipient.
   Genera of the Sender Process, the Micropayments Server Process and the Receiver Process

Although many embodiments were disclosed herein, three genera may be defined into which all species of the sender process, micropayments server process and receiver process fall. Each of the three genera are defined by the common characteristics which all species in the genus share.

The Receiver Process Genus

This genus is defined by two common characteristics: (1) all species will sense the presence of a stemp; and (2) all species determine if the postage encoded in the stemp is adequate either locally or by communication with a micropayments server; (3) all species allow the message to be viewed if the postage is adequate.

The Sender Process Genus

The genus of the sender process (a process separate from the normal email client which sends and receives email but which works with the email client or is integrated into it to carry out the micropayments protocol) is defined by the following common characteristics: (1) all species must have the ability to request an encrypted stemp from a micropayments server; (2) all species must have the ability to receive back a message from the micropayments server with an encrypted stemp and place the encrypted stemp somehow in the email to be sent in a way which will not interfere with normal processing of the packets in the internet or by the receiver process other than to block the email in predetermined circumstances defined herein.

The Micropayments Server Process

The genus of the micropayments server process is defined by the following characteristics: (1) all species must be able to communicate with potential subscribers to set up postage accounts; (2) all species must be able to communicate with sender processes to receive requests for stemps, authenticate the sender process, check for an account and sufficient account balance, and send back an encrypted stemp, debit the account balance, and know the key used to encrypt the stemp for each particular email; (3) all species must be able to communicate with receiver processes so as to assist the receiver process to block spam. This can be done in a variety of ways disclosed above and equivalent ways such as: carrying out a challenge-response protocol with the sender process and sending a message to the recipient computer telling it if the challenge is not responded to or not responded to correctly; inviting the sender to subscribe to a micropayments account and send a message to the recipient computer if the subscription is not entered; and/or maintain a white list for each recipient.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. All such alternative embodiments and other modifications are intended to be included within the scope of the claims appended hereto.

1. A server for a micropayments system comprising:
first means for communicating with computers of potential subscribers to set up micropayment accounts, receive payments and keep track of account balances for each user;
second means for communicating with a micropayment sender process executing on a computer of a sender of email to receive a message requesting stemps, authenticate said sender process, check for a micropayments account for said sender and determine if said account has a sufficient balance to enable issuing a stemp, send back an encrypted stemp to said sender process encoding a micropayment amount and deduct said micropayment amount from said account balance, and know the key used to encrypt said stemp sent to each sender process in response to a request to add a micropayment to each particular email;
third means for communicating with a micropayment receiver process executing on a computer of a recipient of email to assist said receiver process to block spam.

2. The apparatus of claim 1 wherein said second means comprises means for generating a key for encrypting said stemp each time a request is received to send back an encrypted stemp and further comprises means for assigning a unique serial number or identifier to each email which is the subject of a request to send back a stemp, and wherein said second means knows the key used to encrypt said stemp sent to said sender process in response to each request to send a stemp by virtue of the process of generating said key each time such a request is received and storing said key along with the serial number or identifier assigned to said email, and further comprising means which are part of said second means for sending back said unique serial number or identifier with each encrypted stemp.

3. The apparatus of claim 1 wherein said first means comprises registration means for receiving a registration message from a sender process executing on a computer of a user desiring to set up a micropayment account for a user and said registration means for responding to said registration request message by carrying out a protocol to set up said account for said user.

4. The apparatus of claim 3 wherein said registration means further comprises means to respond to said registration message by generating a key which will be used to encrypt all stemps for emails sent to said user, store the key generated for each user upon receiving a registration message from said user in a database of such keys and link said key to said user, and wherein said second means receives information about the recipient identity with every request from a sender process to send back an encrypted stemp for an email message to a recipient and using the recipient identity to look up the key that is to be used to encrypt the stemp from said database of keys for each recipient, and wherein said second means uses the key so found to encrypt the stemp sent to each sender response in response to a request to send an email to said recipient.

5. The apparatus of claim 3 wherein said registration means further comprises means to receive a key generated by each user and included in said user's registration message upon receiving said registration message and storing the key from each said user in a database of such keys, each key linked to the user from which it was received, and wherein said second means receives information about the recipient identity with every request from a sender process to send back an encrypted stemp for an email message to a recipient and uses the recipient identity to look up the key that is to be used to encrypt the stemp from said database of keys for each recipient, and wherein said second means uses the key so found to encrypt the stemp sent to each sender response in response to a request to send an email to said recipient.

6. The apparatus of claim 3 wherein said registration means further comprises means for responding to said registration message by generating a key which will be used to encrypt all stemps for emails sent to said user, store the key generated for each user upon receiving a registration message from said user in a database of such keys and link said key to said user, and send said key generated in response to receipt of each registration message back to said sender process which sent said registration message, and wherein said second means receives information about the recipient identity with every request from a sender process to send back an encrypted stemp for an email message to a recipient uses the recipient identity to look up the key that is to be used to encrypt the stemp from said database of keys for each recipient, and wherein said second means uses the key so found to encrypt the stemp sent to each sender response in response to a request to send an email to said recipient.

7. The apparatus of claim 1 wherein said third means comprises means for receiving a key request message from a receiver process executing on a computer of a recipient of an email that has an encrypted stemp, said request message containing data from which said recipient can be identified and authenticated and including a serial number or identifer included in an email received by said recipient and including a request for a key, said third means responding to said request by identifying and authenticating said recipient using information in said key request message, and if said user is authentic, using said serial number or identifier included in said key request message to look up the key used to encrypt said stemp in the email received by said recipient and send said key back to said receiver process.

8. The apparatus of claim 1 wherein said third means comprises means for receiving a decrypt stemp message from a receiver process executing on a computer of a recipient of an email that has an encrypted stemp, said message containing data from which said recipient can be identified and authenticated or the serial number or identifier of the email received and including a copy of an encrypted stemp included in an email received by said recipient and including a request to decrypt said stemp and indicate if the micropayment of said stemp is adequate, and wherein said third means responds to said request by identifying and authenticating said recipient using information in said decrypt stemp request message, and if said recipient is authentic, using the identity of the recipient or the serial number or identifier of the email to look up a key used to encrypt said stemp at a sender process which sent said email and decrypting said stemp in the stemp decrypt request message received by said recipient, and comparing the amount of micropayment represented by the decrypted stemp to a threshold amount which is adequate and sending back a message to said receiver process indicating whether the micropayment amount is or is not adequate.

9. The apparatus of claim 8 wherein said third means further comprises means for storing a variable threshold table or database which has a programmable threshold determining what adequate micropayments are for each user in said table or database.

10. The apparatus of claim 8 wherein said third means further comprises means for storing a variable threshold table or database which has a programmable threshold determining what adequate micropayments are for each user in said table or database, and for carrying out communications with each user to establish what each user wants its threshold to be and wherein each user can establish different thresholds for different senders.

11. The apparatus of claim 1 wherein said third means comprises means for receiving a message from a receiver process on a recipient computer that indicates the receiver process received an email with no stemp and for determining the email address of the sender and for sending a message to said sender indicating the recipient did not view the email because of insufficient postage and inviting the sender to establish a micropayments account, and for determining if said sender responded with information to establish a valid micropayments account, and, if so, for deducting a micropayment amount adequate to allow the recipient to view the email and sending a message to said recipient indicating the sender had established a micropayments account and that the email can be viewed, but if the sender did not establish a micropayments account, for sending a message to said receiver process on said recipient's computer instructing it to send said email to the trash.

12. The apparatus of claim 11 wherein said third means comprises means for determining the email address of the sender by reading said email address from data included in said message from said receiver process which received said email with no stemp present.

13. The apparatus of claim 1 wherein said third means comprises means for receiving a message from a receiver process on a recipient computer that indicates the receiver process received an email with no stemp and for determining the email address of the sender and for sending a message to said sender containing a challenge question which only a human viewing the challenge could answer and requesting the user to answer the question and send back a response, and for determining if said sender correctly answered the challenge question in a response, and, if a correct challenge response was received, sending a message to said recipient indicating the sender had correctly answered a challenge question and that the email can be viewed, but if the sender did not correctly answer the challenge question, for sending a message to said receiver process on said recipient's computer instructing it to send said email to the trash.

14. The apparatus of claim 1 wherein said third means comprises means for receiving a decrypt stemp message from a receiver process executing on a computer of a recipient of an email that has an encrypted stemp or which arrived without a stemp, said message containing data from which said recipient can be identified and authenticated or the serial number or identifier of the email received and including a copy of an encrypted stemp included in an email received by said recipient or an indication that no stemp was included in said email, and including a request to decrypt said stemp and indicate if the micropayment of said stemp is adequate, and wherein said third means responds to said request by identifying and authenticating said recipient using information in said decrypt stemp request message, and if said recipient is authentic, using the identity of the recipient or the serial number or identifier of the email to look up a key used to encrypt said stemp at a sender process which sent said email and decrypting said stemp in the stemp decrypt request message received by said recipient, and comparing the amount of micropayment represented by the decrypted stemp to a threshold amount stored in a table or database for said recipient, and if the value of micropayment represented by said decrypted stemp is adequate and sending back a message to said receiver process indicating that the micropayment amount is adequate, and, if the decrypted stemp has an inadequate amount of micropayment or no stemp was included in said email at all, sending a message to said sender of said email containing a request to answer a challenge question posed in said message to said sender, said challenge question being a question that only a human viewing said challenge question on a computer screen could successfully answer, and for determining if a correct response to said challenge question was received, and, if so, sending a message to said receiver process executing on the recipient's computer indicating the email can be viewed and, if no correct challenge response was received, sending a message to said receiver process executing on the recipient's computer indicating the email should be discarded or put in a potential spam folder.

15. The apparatus of claim 1 wherein said third means comprises means for receiving a decrypt stemp message from a receiver process executing on a computer of a recipient of an email that has an encrypted stemp or which arrived without a stemp, said message containing data from which said recipient can be identified and authenticated or the serial number or identifier of the email received and including a copy of an encrypted stemp included in an email received by said recipient or an indication that no stemp was included in said email, and including a request to decrypt said stemp and indicate if the micropayment of said stemp is adequate, and wherein said third means responds to said request by identifying and authenticating said recipient using information in said decrypt stemp request message, and if said recipient is authentic, using the identity of the recipient or the serial number or identifier of the email to look up a key used to encrypt said stemp at a sender process which sent said email and decrypting said stemp in the stemp decrypt request message received by said recipient, and comparing the amount of micropayment represented by the decrypted stemp to a threshold amount stored in a table or database for said recipient, and if the value of micropayment represented by said decrypted stemp is adequate and sending back a message to said receiver process indicating that the micropayment amount is adequate, and, if the decrypted stemp has an inadequate amount of micropayment or no stemp was included in said email at all, sending a message to said sender of said email inquiring as to whether said sender would like to establish a micropayments account, and for determining if a request to establish a micropayments account was received and a valid micropayments account was received, and, if so, sending a message to said receiver process executing on the recipient's computer indicating the email can be viewed and, if no valid micropayments account was established by said sender, sending a message to said receiver process executing on the recipient's computer indicating the email should be discarded or put in a potential spam folder.

16. The apparatus of claim 1 wherein said third means comprises means for receiving a message from a receiver process executing on a computer of a recipient of an email that has no encrypted stemp, said message containing data from which said recipient can be identified and authenticated and containing an indication that no stemp was included in an email said recipient received, and identifying the sender of said email and including a request to add said sender to a white list maintained for said recipient by said server, and said third means further comprising means to respond to said request by identifying and authenticating said recipient using information in said message, and if said recipient is authentic, adding the sender to a white list maintained by said server for said recipient, and sending a message to said sender indicating said recipient has added the sender to the recipient's white list and that the sender can thereafter send emails to this recipient with no micropayments.

17. The apparatus of claim 1 wherein said third means comprises means for receiving a message from a receiver process executing on a computer of a recipient of an email that has no encrypted stemp, said message containing data from which said recipient can be identified and authenticated and containing an indication that no stemp was included in an email said recipient received, and identifying the sender of said email and including a request to add said sender to a white list maintained for said recipient by said server, and said third means further comprising means to respond to said request by identifying and authenticating said recipient using information in said message, and if said recipient is authentic, adding the sender to a white list maintained by said server for said recipient, said white list containing a programmable threshold amount each recipient has set to receive email from various senders or classes of senders, and sending a message to said sender indicating the threshold amount said recipient has established to receive email from this sender and inquiring whether the sender would like to establish a micropayments account and pay the threshold amount therefrom to allow the email message to be viewed by the recipient or, if the sender already has a micropayments account, inquiring whether the sender would like to deduct the threshold amount from the sender's micropayment account in order to cause the server to send a message to said recipient that it is permissible to view the email, and if the sender does not have a micropayments account and does not establish one or indicates he does not want the threshold amount deducted from his micropayments account, sending a message to said receiver process executing on recipient's computer indicating the email message should not be viewed or placed in a potential spam folder, and if the sender sends back a message indicating he or she would like to have the threshold amount deducted from an already existing micropayment account for this sender or establish a micropayments account and have the threshold amount deducted therefrom, deducting the threshold amount from the sender's already existing micropayment account or establishing a micropayments account for said sender and deducting the threshold amount from said account, as appropriate, and sending a message to said receiver process executing on the recipient's computer indicating the email can be viewed.

18. The apparatus of claim 1 further comprising fourth means for transferring value to a recipients micropayments account or the account of another designated by the recipient when a transfer value message is received at said server.

19. A process to transfer micropayment value from one email user to another, comprising the steps:
1) receiving at a micropayments server a micropayment value transfer message from a sender computer of a sender of email or from a recipient computer of a recipient of email;
2) identify and authenticate the sender of the value transfer message, sender meaning the person who wishes to transfer a micropayment amount out of his or her account to another user's account;
3) verifying that said sender of said value transfer message has a valid micropayments account with an adequate balance for the transfer;
4) deduct the transferred amount from said sender's account and deposit said transferred amount into said recipient's account.

20. The process of claim 19 further comprising the step of sending back an encrypted stemp to said sender of said value transfer message after step 4 if said value transfer message came directly to said server from said sender, and sending a message to said recipient computer indicating the amount of micropayment transferred into the recipient's account.

21. A process carried out on a micropayments server which is coupled via a data path to recipient computers and sender computers, comprising the steps:
1) communicating with at least said sender computers to establish micropayment accounts, receive payments and keep track of account balances for each user;
2) receiving a request message from a sender computer indicating a user of said sender computer wishes to send an email with a micropayment as part thereof and including information by which said sender computer can be identified and authenticated;
3) responding to said request message by identifying and authenticating said sender computer and determining if said sender computer has a micropayments account and determining if the balance of said micropayments account is adequate for the amount of micropayment to be made;
4) if said sender computer has a micropayments account with a balance adequate for said micropayment, deducting the amount of a micropayment from said account balance;
5) generating an encrypted stemp encoding the amount of the deducted micropayment and sending said encrypted stemp to said sender computer and maintain knowledge of an encryption key used to encrypt said stemp;
6) communicating with recipient computers to assist them in accepting predetermined emails and rejecting other predetermined emails so as to reduce the amount of spam email which is viewed by a user of said recipient computers.

22. The process of claim 21 further comprising the steps:
7) receiving at said micropayments server a micropayment value transfer message from a sender computer of a sender of email or from a recipient computer of a recipient of email, said value transfer message being either part of said request message received in step 2 or a separate message;
8) identifying and authenticating the sender of the value transfer message, sender meaning the person who wishes to transfer a micropayment amount out of his or her account to another user's account;
9) verifying that said sender of said value transfer message has a valid micropayments account with an adequate balance for the transfer;
10) deducting the transferred amount from said sender's account and deposit said transferred amount into said recipient's account.

23. The process of claim 22 further comprising the step of sending a message to said recipient computer indicating the amount of micropayment transferred into the recipient's account.

23. The process of claim 21 wherein step 5 comprises the steps of:
generating a key for encrypting said stemp each time a request is received to send back an encrypted stemp;
assigning a unique serial number or identifier to each email which is the subject of a request to send back a stemp;
storing said key along with said serial number or identifier assigned to said email;
sending back said unique serial number or identifier with each encrypted stemp.

24. The process of claim 21 wherein step 1 comprises the following steps:
receiving a registration message from a process executing on a sender computer of a user desiring to set up a micropayment account for a user;
responding to said registration request message by carrying out a protocol to set up said micropayment account for said user;
responding to said registration message by generating a key in said micropayments server, said key for use in future encryption of all stemps for emails sent to said user of said sender computer which sent said registration message;
storing said key generated for each user in a database of such keys and link said key to said user;
and wherein step 2 comprises
receiving information about the identity of the recipient on the email which is the subject of said request message received in step 2 and using the recipient's identity to look up from said database of keys for each recipient the key that is to be used to encrypt the stemp for said email to be sent to said recipient;
and wherein step 5 comprises the steps:
using the key so found to encrypt the stemp sent to said sender computer for sending in an email to said recipient computer.

25. The process of claim 21 wherein step 1 comprises the following steps:
receiving a registration message from a process executing on a sender computer of a user desiring to set up a micropayment account for a user;
responding to said registration request message by carrying out a protocol to set up said micropayment account for said user;
responding to said registration message by generating a key in said micropayments server, said key for use in future encryption of all stemps for emails sent to said user of said sender computer which sent said registration message;
storing said key generated for each user in a database of such keys and link said key to said user; and send said key back to said computer which sent said registration message for use in decrypting stemps of incoming emails;
and wherein step 2 comprises
receiving information about the identity of the recipient on the email which is the subject of said request message received in step 2 and using the recipient's identity to look up from said database of keys for each recipient the key that is to be used to encrypt the stemp for said email to be sent to said recipient;
and wherein step 5 comprises the steps:
using the key so found to encrypt the stemp sent to said recipient.

26. The process of claim 21:
wherein step 1 further comprises the steps of receiving a key generated by each user and included in said user's registration message upon receiving said registration message;
storing said key received from each said user in a database of such keys, each key linked to the user from which it was received;
and wherein step 2 further comprises the steps of:
receiving information about the recipient identity with every said request message received and using the recipient identity to look up the key that is to be used to encrypt the stemp from said database of keys for each recipient;
and wherein step 5 further comprises the steps of:
using said key so found to encrypt said stemp sent to each sender response in response to a request to send an email to said recipient.

27. The process of claim 21:
wherein step 5 further comprises the steps:
generating a key unique to the email which is the subject of said request message received in step 2 and generating a serial number or identifier which is unique to said email which is the subject of said request message received in step 2;
storing said key and serial number or identifier so that said key can be looked up using said serial number or identifier;
and wherein step 5 comprises:
using said key so generated which is unique to said email to encrypt a stemp encoding a micropayment amount and sending said encrypted stemp along with said serial number or identifier to said computer which sent said request message for inclusion in said email;
and wherein step 6 comprises the steps:
receiving a key request message from a recipient computer which has received an email that has an encrypted stemp, said request message containing data from which said recipient computer can be identified and authenticated and including a serial number or identifer included in an email received by said recipient and including a request for a key to decrypt said encrypted stemp;
responding to said key request message by identifying and authenticating said recipient computer using information in said key request message, and if said user is authentic, using said serial number or identifier included in said key request message to look up the key used to encrypt said stemp in the email received by said recipient and send said key back to said recipient computer.

28. The process of claim 21 wherein step 6 comprises the steps:
receiving a decrypt stemp request message from a recipient computer which has received an email that has an encrypted stemp, said decrypt stemp message containing data from which said recipient computer can be identified and authenticated and including a serial number or identifier included in said email which was received and including a copy of an encrypted stemp included in an email received by said recipient and including a request to decrypt said stemp;
responding to said decrypt stemp request message by identifying and authenticating said recipient computer using information in said decrypt stemp request message;
if said recipient computer is authentic, looking up the key that was used to encrypt said stemp at a sender computer which sent said email and decrypting said stemp included in the stemp decrypt request message; and
sending back to recipient computer a message to said recipient computer indicating whether the micropayment amount is or is not adequate.

29. The process of claim 21 wherein step 6 comprises the steps:
receiving a decrypt stemp request message from a recipient computer which has received an email that has an encrypted stemp, said decrypt stemp message containing data from which said recipient computer can be identified and authenticated and including a serial number or identifier included in said email which was received and including a copy of an encrypted stemp included in an email received by said recipient and including a request to decrypt said stemp;
responding to said decrypt stemp request message by identifying and authenticating said recipient computer using information in said decrypt stemp request message;
if said recipient computer is authentic, looking up the key that was used to encrypt said stemp at a sender computer which sent said email and decrypting said stemp included in the stemp decrypt request message and looking up a micropayment threshold amount for this recipient computer or for this recipient computer based upon the identity of this particular sender;
comparing the decrypted stemp amount to the value of said micropayment threshold; and
sending back to recipient computer a message to said recipient computer indicating whether the micropayment amount is or is not adequate.

30. The process of claim 21 wherein step 6 comprises the steps:
receiving a decrypt stemp request message from a recipient computer which has received an email that has an encrypted stemp, said decrypt stemp message containing data from which said recipient computer can be identified and authenticated and including a serial number or identifier included in said email which was received and including a copy of an encrypted stemp included in an email received by said recipient and including a request to decrypt said stemp;
responding to said decrypt stemp request message by identifying and authenticating said recipient computer using information in said decrypt stemp request message;
if said recipient computer is authentic, looking up the key that was used to encrypt said stemp at a sender computer which sent said email and decrypting said stemp included in the stemp decrypt request message; and
sending back the decrypted stemp to said recipient computer or a message to said recipient computer indicating whether the micropayment amount is or is not adequate.

31. The process of claim 21 wherein step 6 comprises the steps:
receiving a decrypt stemp request message from a recipient computer which has received an email that has an encrypted stemp, said decrypt stemp message containing data from which said recipient computer can be identified and authenticated and including a copy of an encrypted stemp included in an email received by said recipient and including a request to decrypt said stemp;
responding to said decrypt stemp request message by identifying and authenticating said recipient computer using information in said decrypt stemp request message;
if said recipient computer is authentic, looking up the key that was used to encrypt said stemp at a sender computer which sent said email, said key being established by said server for said recipient computer at the time the user of said recipient computer first established a micropayments account;
decrypting said stemp included in the stemp decrypt request message using said key associated with said recipient computer; and
sending back the decrypted stemp to said recipient computer or a message to said recipient computer indicating whether the micropayment amount is or is not adequate.

32. The process of claim 21 wherein step 6 comprises the steps:
receiving a decrypt stemp request message from a recipient computer which has received an email that has an encrypted stemp, said decrypt stemp message containing data from which said recipient computer can be identified and authenticated and including a copy of an encrypted stemp included in an email received by said recipient and including a request to decrypt said stemp;
responding to said decrypt stemp request message by identifying and authenticating said recipient computer using information in said decrypt stemp request message;
if said recipient computer is authentic, looking up the key that was used to encrypt said stemp at a sender computer which sent said email, said key being established by said recipient computer at the time the user of said recipient computer first established a micropayments account;
decrypting said stemp included in the stemp decrypt request message using said key associated with said recipient computer; and
sending back the decrypted stemp to said recipient computer or a message to said recipient computer indicating whether the micropayment amount is or is not adequate.

33. The process of claim 21:
wherein step 1 comprises the steps:
after establishing a micropayment account for each user, carrying out communications with each user to establish what each user wants its micropayment threshold to be either in general for all incoming emails or so as to establish different micropayment thresholds for different senders;
and wherein step 6 comprises the steps:
receiving a decrypt stemp request message from a recipient computer which has received an email that has an encrypted stemp, said decrypt stemp message containing data from which said recipient computer can be identified and authenticated and including a serial number or identifier included in said email which was received and including a copy of an encrypted stemp included in an email received by said recipient and including a request to decrypt said stemp;
responding to said decrypt stemp request message by identifying and authenticating said recipient computer using information in said decrypt stemp request message;
if said recipient computer is authentic, looking up the key that was used to encrypt said stemp at a sender computer which sent said email and decrypting said stemp included in the stemp decrypt request message and looking up a micropayment threshold amount for this recipient computer or for this recipient computer based upon the identity of this particular sender;
comparing the decrypted stemp amount to the value of said micropayment threshold; and
sending back to recipient computer a message to said recipient computer indicating whether the micropayment amount is or is not adequate.

34. The process of claim 21 wherein step 6 comprises the steps:
receiving a decrypt stemp request message from a recipient computer which has received an email that has an encrypted stemp, said decrypt stemp message containing data from which said recipient computer can be identified and authenticated and including a copy of an encrypted stemp included in an email received by said recipient and including a request to decrypt said stemp;
responding to said decrypt stemp request message by identifying and authenticating said recipient computer using information in said decrypt stemp request message;
if said recipient computer is authentic, looking up the key that was used to encrypt said stemp at a sender computer which sent said email and decrypting said stemp included in the stemp decrypt request message;
communicating with said recipient computer to tell it how much the micropayment amount was in said encrypted stemp and inquiring how high to set a micropayment threshold to receive mail from this particular sender computer;
receiving a reply threshold amount from said recipient computer and comparing the decrypted stemp amount to the value of said micropayment threshold; and
if the micropayment amount is adequate, sending back to recipient computer a message to said recipient computer indicating the micropayment amount is adequate;
if the micropayment amount is inadequate, sending a message to said sender computer indicating how much micropayment this sender computer must include in emails to said recipient computer in order for said emails to not be blocked and inquiring whether the user of said sender computer wishes to increase the micropayment amount;
receiving a message back from said sender computer, if any, and if said reply message indicates the user of said sender computer is willing to increase the micropayment amount on the email received by said recipient computer, authenticating said sender computer, checking for an adequate balance, and, if said balance is adequate, deducting the additional micropayment amount from said balance and sending a message to said recipient computer indicating it is permissible to unblock said email from said sender computer.

35. The process of claim 21 wherein step 6 comprises:
receiving a message from a recipient computer that indicates an email with no stemp has been received;
determining the email address of the sender of said email with no stemp;
sending a message to said sender indicating a user of said recipient computer did not view said email with no stemp because of insufficient postage and inviting said sender to establish a micropayments account;
determining if said sender responded with information to establish a valid micropayments account;
if said sender did establish and fund a micropayments account, deducting a micropayment amount adequate to allow said user of said recipient computer to view said email and sending a message to said user of said recipient computer indicating said sender has established a micropayments account and that the email can be viewed;
but if said sender did not establish and fund a micropayments account, sending a message to said recipient computer instructing it to send said email to the trash.

36. The process of claim 35 wherein said step of determining said email address of said sender comprises reading said email address from said message received from said recipient computer.

37. The process of claim 21 wherein step 6 comprises the steps:
receiving a message from a recipient computer that indicates the receiver process received an email with no stemp;
determining the email address of the sender of said email message, and sending a message to said sender containing a challenge question which only a human viewing the challenge could answer and requesting the user to answer the question and send back a response;
determining if said sender correctly answered said challenge question in a response;
if a correct challenge response was received, sending a message to said recipient computer indicating the sender has correctly answered a challenge question and that the email can be viewed;
if the sender of said email question did not correctly answer said challenge question, sending a message to said recipient computer instructing it to send said email to the trash.

38. The process of claim 21 wherein step 6 includes the steps:
receiving a decrypt stemp message from a recipient computer which received an email that has an encrypted stemp as part of said email message or which arrived without a stemp, said decrypt stemp message containing data from which a key used to encrypt any stemp in said email message can be found, said decrypt stemp message also including a copy of an encrypted stemp included in said email or an indication that no stemp was included in said email, said decrypt stemp message also including a request to decrypt said stemp;
identifying and authenticating said recipient computer using information in said decrypt stemp request message;
if said recipient is authentic, using information in said decrypt stemp message to look up an encryption key used to encrypt said stemp at a sender computer which sent said email;
using said key to decrypt said stemp in said decrypt stemp request message.

39. The process of claim 38 further comprising the steps:
comparing the amount of micropayment represented by the decrypted stemp to a threshold amount stored in a table or database for said recipient;
if the value of micropayment represented by said decrypted stemp is adequate, sending back a message to said recipient computer indicating that said micropayment amount is adequate;
if said decrypted stemp has an inadequate amount of micropayment or no stemp was included in said email at all, sending a message to said sender of said email containing a request to answer a challenge question posed in said message to said sender, said challenge question being a question that only a human viewing said challenge question on a computer screen could successfully answer;
determining if a correct response to said challenge question was received;
if a correct response was received, sending a message to said recipient's computer indicating the email can be viewed;
if no correct response was received to said challenge question, sending a message to said recipient computer indicating the email should be discarded or put in a potential spam folder.

40. The process of claim 38 further comprising the step of sending back said decrypted stemp to said recipient computer.

41. The process of claim 21 wherein step 6 includes the steps:
receiving a decrypt stemp message from a recipient computer which received an email that has an encrypted stemp as part of said email message or which arrived without a stemp, said decrypt stemp message containing data from which a key used to encrypt any stemp in said email message can be found, said decrypt stemp message also including a copy of an encrypted stemp included in said email or an indication that no stemp was included in said email, said decrypt stemp message also including a request to decrypt said stemp;
identifying and authenticating said recipient computer using information in said decrypt stemp request message;
if said recipient is authentic, using information in said decrypt stemp message to look up an encryption key used to encrypt said stemp at a sender computer which sent said email;
using said key to decrypt said stemp in said decrypt stemp request message;
comparing the amount of micropayment represented by the decrypted stemp to a threshold amount stored in a table or database for said recipient;
if the value of micropayment represented by said decrypted stemp is adequate, sending back a message to said recipient computer indicating that said micropayment amount is adequate;
if said decrypted stemp has an inadequate amount of micropayment or no stemp was included in said email at all, sending a message to said sender of said email indicating the email said sender sent was not viewed by the recipient and will not be viewed unless a micropayment is made, and inviting said sender to establish and fund a micropayment account;
determining if said sender established and funded a micropayment account;
if said sender established and funded a micropayment account, deducting an predetermined amount from said account, and sending a message to said recipient computer indicating the email can be viewed;
if said sender did not establish and fund a micropayment account, sending a message to said recipient computer indicating said email should be discarded or put in a potential spam folder.

42. The process of claim 21 wherein step 6 includes the steps:
receiving a white list request message from a recipient computer which has received an email that has no encrypted stemp but which is from a sender which the recipient wishes to add to the recipients white list, said message containing data from which said recipient computer can be identified and authenticated and containing an indication that no stemp was included in an email said recipient received, and identifying the sender of said email and including a request to add said sender to a white list maintained for said recipient by said server;
responding to said white list request message by identifying and authenticating said recipient computer using information in said white list request message;
if said recipient computer is authentic, adding the sender of said email to a white list maintained by said server for said recipient, and sending a message to said sender indicating said recipient has added the sender to the recipient's white list and that the sender can thereafter send emails to this recipient with no micropayments; and
if the computer which sent said request message is not authenticated as the recipient's computer, doing nothing and not adding the sender to the recipient's white list.

43. The process of claim 21 wherein step 6 comprises the steps:
receiving a white list request message from a recipient computer that an email that has no encrypted stemp has been received, said message also containing data from which said recipient can be identified and authenticated and identifying the sender of said email and including a request to add said sender to a white list maintained for said recipient by said server;
responding to said white list request message by identifying and authenticating said recipient computer using information in said white list request message, and if said recipient computer is authentic, adding the sender to a white list maintained by said server for said recipient, said white list containing a programmable threshold amount each recipient has set to receive email from various senders or classes of senders;
sending a message to said sender indicating the threshold amount said recipient has established to receive email from this sender and inquiring whether the sender would like to establish a micropayments account and pay the threshold amount therefrom to allow the email message to be viewed by the recipient or, if the sender already has a micropayments account, inquiring whether the sender would like to deduct the threshold amount from the sender's micropayment account in order to cause the server to send a message to said recipient that it is permissible to view the email;
determining if the sender does not have a micropayments account and does not establish one or indicates he does not want the threshold amount deducted from his micropayments account, and, if either of these event occurs, sending a message to said recipient computer indicating the email message should not be viewed or placed in a potential spam folder;
if the sender sends back a message indicating he or she would like to have the threshold amount deducted from an already existing micropayment account for this sender or establish a micropayments account and have the threshold amount deducted therefrom, deducting the threshold amount from the sender's already existing micropayment account or establishing a micropayments account for said sender and deducting the threshold amount from said account, as appropriate; and
sending a message to said recipient computer indicating the email can be viewed.

44. The process of claim wherein step 6 comprises the steps:
receiving a white list request message from a recipient computer that an email that has no encrypted stemp has been received, said message also containing data from which said recipient can be identified and authenticated and identifying the sender of said email and including a request to add said sender to a white list maintained for said recipient by said server;
responding to said white list request message by identifying and authenticating said recipient computer using information in said white list request message, and if said recipient computer is authentic, adding the sender to a white list maintained by said server for said recipient, said white list containing a programmable threshold amount each recipient has set to receive email from various senders or classes of senders;
sending a message to said sender indicating the threshold amount said recipient has established to receive email from this sender and inquiring whether the sender would like to establish a micropayments account and pay the threshold amount therefrom to allow the email message to be viewed by the recipient or, if the sender already has a micropayments account, inquiring whether the sender would like to deduct the threshold amount from the sender's micropayment account in order to cause the server to send a message to said recipient that it is permissible to view the email;
determining if the sender does not have a micropayments account and does not establish one or indicates he does not want the threshold amount deducted from his micropayments account, and, if either of these event occurs, sending a message to said recipient computer indicating the email message should not be viewed or placed in a potential spam folder;
if the sender sends back a message indicating he or she would like to have the threshold amount deducted from an already existing micropayment account for this sender or establish a micropayments account and have the threshold amount deducted therefrom, deducting the threshold amount from the sender's already existing micropayment account or establishing a micropayments account for said sender and deducting the threshold amount from said account, as appropriate; and
sending a message to said recipient computer indicating the email can be viewed and indicating how much value will be transferred to the recipient's micropayments account, or the account of another designated by the recipient if the recipient opens the message, and waiting for confirmation that the recipient opened the message;
if a confirmation message is received from said recipient computer which is automatically generated when a recipient opens an email message which indicates the recipient opened said email sent by said sender, authenticating said recipient computer which opened said message using information in said confirmation message, and transferring the amount deducted from sender's micropayments account to said recipient's micropayments account or to the account of another designated by the recipient.

45. A process carried out on a micropayments server which is coupled via a data path to recipient computers and sender computers, comprising the steps:
1) communicating with at least said sender computers to establish micropayment accounts, receive payments and keep track of account balances for each user;
2) receiving a request message from a sender computer indicating a user of said sender computer wishes to send an email with a micropayment as part thereof and including information by which said sender computer can be identified and authenticated;
3) responding to said request message by identifying and authenticating said sender computer and determining if said sender computer has a micropayments account and determining if the balance of said micropayments account is adequate for the amount of micropayment to be made;
4) if said sender computer has a micropayments account with a balance adequate for said micropayment, deducting the amount of a micropayment from said account balance;
5) generating an encrypted stemp encoding the amount of the deducted micropayment and sending said encrypted stemp to said sender computer and maintain knowledge of an encryption key used to encrypt said stemp;
6) communicating with recipient computers to assist them in accepting predetermined emails and rejecting other predetermined emails so as to reduce the amount of spam email which is viewed by a user of said recipient computers; and
7) transferring value to a recipients micropayments account or to the account of another designated by said recipient when a transfer value message is received at said server.

46. A computer readable medium having computer-executable instructions thereon for controlling an email micropayments server coupled through a wide area network such as the internet to a plurality of sender and recipient computers to execute the following process:
1) communicating with at least said sender computers to establish micropayment accounts, receive payments and keep track of account balances for each user;
2) receiving a request message from a sender computer indicating a user of said sender computer wishes to send an email with a micropayment as part thereof and including information by which said sender computer can be identified and authenticated;
3) responding to said request message by identifying and authenticating said sender computer and determining if said sender computer has a micropayments account and determining if the balance of said micropayments account is adequate for the amount of micropayment to be made;
4) if said sender computer has a micropayments account with a balance adequate for said micropayment, deducting the amount of a micropayment from said account balance;
5) generating an encrypted stemp encoding the amount of the deducted micropayment and sending said encrypted stemp to said sender computer and maintain knowledge of an encryption key used to encrypt said stemp;
6) communicating with recipient computers to assist them in accepting predetermined emails and rejecting other predetermined emails so as to reduce the amount of spam email which is viewed by a user of said recipient computers.

47. The computer readable medium of claim 46 having further computer-executable instructions thereon to control said email micropayments server to also perform the function of transferring value to a recipients micropayments account or the account of another designated by the recipient when a transfer value message is received at said email micropayments server.

48. The computer readable medium of claim 46 having further computer-executable instructions thereon to control said email micropayments server to also perform the functions of:
receiving a transfer value message either from a sender computer or from a recipient computer which has received a transfer value message directly from a sender computer;
authenticating a computer which sent said transfer value message using information in said transfer value message;
transferring value to a recipients micropayments account when a transfer value message is received at said email micropayments server from a computer which has been properly authenticated.

49. The computer readable medium of claim 46 having further computer-executable instructions thereon to control said email micropayments server to also perform the functions of:
receiving at said micropayments server a micropayment value transfer message from a sender computer of a sender of email or from a recipient computer of a recipient of email, said value transfer message being either part of said request message received in step 2 or a separate message;
identifying and authenticating the sender of the value transfer message, sender meaning the person who wishes to transfer a micropayment amount out of his or her account to another user's account;
verifying that said sender of said value transfer message has a valid micropayments account with an adequate balance for the transfer;
deducting the transferred amount from said sender's account and deposit said transferred amount into said recipient's account.

50. The computer readable medium of claim 46 wherein said computer-executable instructions thereon to control said email micropayments server to perform the function of step 5 comprise computer executable instructions to control a computer to execute step 5 by:
generating a key for encrypting said stemp each time a request is received to send back an encrypted stemp;
assigning a unique serial number or identifier to each email which is the subject of a request to send back a stemp;
storing said key along with said serial number or identifier assigned to said email;
sending back said unique serial number or identifier with each encrypted stemp.

51. The computer readable medium of claim 46 wherein said computer-executable instructions thereon to control said email micropayments server to perform the function of step 1 comprise computer executable instructions to control said email micropayments server to execute step 1 by:
receiving a registration message from a process executing on a sender computer of a user desiring to set up a micropayment account for a user;
responding to said registration request message by carrying out a protocol to set up said micropayment account for said user;
responding to said registration message by generating a key in said micropayments server, said key for use in future encryption of all stemps for emails sent to said user of said sender computer which sent said registration message;
storing said key generated for each user in a database of such keys and link said key to said user;
and wherein said computer executable instructions which control said email micropayments server to execute step 2 comprise computer-executable instructions to control said email micropayments server to execute step 2 by:
receiving information about the identity of the recipient on the email which is the subject of said request message received in step 2 and using the recipient's identity to look up from said database of keys for each recipient the key that is to be used to encrypt the stemp for said email to be sent to said recipient;
and wherein said computer executable instructions which control said email micropayments server to execute step 5 comprise computer-executable instructions to control said email micropayments server to execute step 5 by:
using the key so found to encrypt the stemp sent to said sender computer for sending to said recipient.

52. The computer readable medium of claim 46 wherein said computer-executable instructions thereon to control said email micropayments server to perform the function of step 1 comprise computer executable instructions to control said email micropayments server to execute step 1 by:
receiving a registration message from a process executing on a sender computer of a user desiring to set up a micropayment account for a user;
responding to said registration request message by carrying out a protocol to set up said micropayment account for said user;
responding to said registration message by generating a key in said micropayments server, said key for use in future encryption of all stemps for emails sent to said user of said sender computer which sent said registration message;
storing said key generated for each user in a database of such keys and link said key to said user; and
send said key back to said computer which sent said registration message for use in decrypting stemps of incoming emails;
and wherein said computer executable instructions which control said email micropayments server to execute step 2 comprise computer-executable instructions to control said email micropayments server to execute step 2 by:
receiving information about the identity of the recipient on the email which is the subject of said request message received in step 2 and using the recipient's identity to look up from said database of keys for each recipient the key that is to be used to encrypt the stemp for said email to be sent to said recipient;
and wherein said computer executable instructions which control said email micropayments server to execute step 5 comprise computer-executable instructions to control said email micropayments server to execute step 5 by:
using the key so found to encrypt the stemp sent to said sender computer for sending to said recipient.

53. The computer readable medium of claim wherein said computer-executable instructions thereon to control said email micropayments server to perform the function of step 6 comprise computer executable instructions to control said email micropayments server to execute step 6 by:
receiving a decrypt stemp request message from a recipient computer which has received an email that has an encrypted stemp, said decrypt stemp message containing data from which said recipient computer can be identified and authenticated and including a serial number or identifier included in said email which was received and including a copy of an encrypted stemp included in an email received by said recipient and including a request to decrypt said stemp;
responding to said decrypt stemp request message by identifying and authenticating said recipient computer using information in said decrypt stemp request message;
if said recipient computer is authentic, looking up the key that was used to encrypt said stemp at a sender computer which sent said email and decrypting said stemp included in the stemp decrypt request message; and
sending back to recipient computer a message to said recipient computer indicating whether the micropayment amount is or is not adequate.

54. The computer readable medium of claim 46 wherein said computer-executable instructions thereon to control said email micropayments server to perform the function of step 1 comprise computer executable instructions to control said email micropayments server to execute step 1 by:
after establishing a micropayment account for each user, carrying out communications with each user to establish what each user wants its micropayment threshold to be either in general for all incoming emails or so as to establish different micropayment thresholds for different senders;
and wherein said computer executable instructions which control said email micropayments server to execute step 6 comprise computer-executable instructions to control said email micropayments server to execute step 6 by:
receiving a decrypt stemp request message from a recipient computer which has received an email that has an encrypted stemp, said decrypt stemp message containing data from which said recipient computer can be identified and authenticated and including a serial number or identifier included in said email which was received and including a copy of an encrypted stemp included in an email received by said recipient and including a request to decrypt said stemp;
responding to said decrypt stemp request message by identifying and authenticating said recipient computer using information in said decrypt stemp request message;
if said recipient computer is authentic, looking up the key that was used to encrypt said stemp at a sender computer which sent said email and decrypting said stemp included in the stemp decrypt request message and looking up a micropayment threshold amount for this recipient computer or for this recipient computer based upon the identity of this particular sender;
comparing the decrypted stemp amount to the value of said micropayment threshold; and
sending back to recipient computer a message to said recipient computer indicating whether the micropayment amount is or is not adequate.

55. The computer readable medium of claim 46 wherein said computer-executable instructions thereon to control said email micropayments server to perform the function of step 6 comprise computer executable instructions to control said email micropayments server to execute step 6 by:
receiving a message from a recipient computer that indicates an email with no stemp has been received;
determining the email address of the sender of said email with no stemp;
sending a message to said sender indicating a user of said recipient computer did not view said email with no stemp because of insufficient postage and inviting said sender to establish a micropayments account;
determining if said sender responded with information to establish a valid micropayments account;
if said sender did establish and fund a micropayments account, deducting a micropayment amount adequate to allow said user of said recipient computer to view said email and sending a message to said user of said recipient computer indicating said sender has established a micropayments account and that the email can be viewed;
but if said sender did not establish and fund a micropayments account, sending a message to said recipient computer instructing it to send said email to the trash.

56. The computer readable medium of claim 46 wherein said computer-executable instructions thereon to control said email micropayments server to perform the function of step 6 comprise computer executable instructions to control said email micropayments server to execute step 6 by:
receiving a message from a recipient computer that indicates the receiver process received an email with no stemp;
determining the email address of the sender of said email message, and sending a message to said sender containing a challenge question which only a human viewing the challenge could answer and requesting the user to answer the question and send back a response;
determining if said sender correctly answered said challenge question in a response;
if a correct challenge response was received, sending a message to said recipient computer indicating the sender has correctly answered a challenge question and that the email can be viewed;
if the sender of said email question did not correctly answer said challenge question, sending a message to said recipient computer instructing it to send said email to the trash.
